(19) United States
(12) Patent Application Publication
(10) Pub. No.: US 2024/0052457 A1
(43) Pub. Date: Feb. 15, 2024

(54) THIN FLUID LAYERS AND STREAMS FACILITATED, FORCE-BASED ATOM, ION, MOLECULE, AND FINE PARTICLE SEPARATORS AND METHODS OF USING THE SAME

(71) Applicant: UNIVERSITY OF UTAH RESEARCH FOUNDATION, Salt Lake City, UT (US)

(72) Inventors: Michael L. Free, Salt Lake City, UT (US); Prashant K. Sarswat, Salt Lake City, UT (US); Benjamin D. Schroeder, Salt Lake City, UT (US)

(21) Appl. No.: 18/447,171

(22) Filed: Aug. 9, 2023

Related U.S. Application Data
(60) Provisional application No. 63/396,670, filed on Aug. 10, 2022.

(51) Int. Cl. C22B 9/02; B01D 21/26; B01D 21/00; B03C 1/28; B03C 1/30; B03C 5/00; B01D 59/24; C22B 26/22; C22B 26/12

(52) U.S. Cl. CPC C22B 9/02; B01D 21/262; B01D 21/0009; B03C 1/288; B03C 1/30; B03C 5/005; B01D 59/24; C22B 26/22; C22B 26/12; B03C 2201/18

(57) ABSTRACT

Separators configured to create and use thin fluid layers, tubes, channels, or streams, multi-port collections, and one or more forces to separate and recover elements, molecules, ions, isotopes, and particles (“entities”). The separators include a support. The support may include inclined surfaces, rotatable cylinders, channels, tubes, streams or sets thereof. The separators may allow for the creation of a thin fluid layer or stream on the surface of the support or on a collection of small tubes, channels, or streams by dispensing a fluid onto the surface or collection of tubes, channels, or streams. Depending on properties of the entities to be separated, the separators can include a force application device configured to subject the entities to a magnetic field, an electrical and/or electrostatic field, a centrifugal field, an electrolytic field, an oscillating field, a hydrophobic gradient, a hydrophilic gradient, or a concentration gradient to facilitate the separations.

### CROSS-REFERENCE TO RELATED APPLICATIONS

This application claims priority to and the benefit of U.S. Provisional Patent Application Ser. No. 63/396,670 entitled THIN LIQUID FILM SEPARATORS AND METHODS OF USING THE SAME, filed Aug. 10, 2022 which is herein incorporated by reference in its entirety.

### STATEMENT REGARDING FEDERALLY SPONSORED RESEARCH OR DEVELOPMENT

N/A.

### FIELD OF THE INVENTION

The present invention generally relates to systems, devices, and methods for separating various materials.

### BACKGROUND

Fluid based separations of ions, molecules, and ultrafine particles is important to many technologies including large-scale commercial applications, such as desalination, metal separation, chemical separations, and water purification, as well as smaller niche applications in isotope separation and fine particle removal. For example, ion separation technologies are important to the separation and recovery of metals in commercial metal recovery and purification processes. Molecular separations, such as the separation of hydrocarbons, are performed on very large scales commercially. Isotopes are critical to a variety of applications including physical science analyses, biology, medicine, pharmaceuticals, and national security, and their accurate separation is critical to their niche uses. Ultrafine particle removal is very important to many industries in which contamination is detrimental to performance.

Additionally, the continuous availability of fresh water is one of the main factors in sustainable development in many regions of the world. Many water resources have been utilized to their full potential in arid regions, and growth in many of these regions is limited by water availability. In some cases, the rate of evaporation of freshwater resources concentrates salts, making it difficult to utilize some available resources. In order to address this need for water in such regions, desalination has become a common practice, but it is relatively expensive, and it consumes a significant amount of energy. Improvements in desalination technology and a reduction in associated costs have the potential to improve water resources by making desalination more economically and technically feasible. It has been reported that almost half as many desalination plants were built in the period of 2000-2010 as were those built in the preceding three decades. This indicates that a limited number of facilities use thermal (evaporation) methods and reverse osmosis (RO). However, other processes are membrane based. Some of these processes are nanofiltration (NF), seawater RO (SWRO), brackish water RO (BWRO), and electrodialysis reversal (EDR). These plants are further categorized as potable water, water for disposal or recycle, and facility aquifer recharge.

The municipal desalination industry is transitioning toward high recovery processing, known as volume reduction or concentrate minimization. Water reuse, or water that has been reclaimed through wastewater treatment, but may not be suitable for core household or domestic use, can also fulfill a need by providing supply for irrigation or industrial users.

In most arid locations, the most widely used effective separation technology for desalination is reverse osmosis. However, the requirement of high pressures and frequent replacement of membrane modules is challenging. Thus, there are opportunities to improve the efficiency and to reduce the cost of desalination.

However, current separation techniques utilize relatively expensive equipment, have generally small separation coefficients thereby requiring cascades of separation units to achieve needed product purity levels, utilize one method or force to facilitate separation, are slow, limited to the separation of two entities, require elevated pressures and membranes that are subject to plugging, and/or are not tunable for effective separation of multiple constituents from a stream containing more than two entities. Further, some separation processes (e.g., distillation) require large inputs of energy to change the state of molecules undergoing separation. Additionally, many isotope separation technologies utilize gas-based separations, which require chemical and state conversion to gaseous compounds that are typically toxic and often corrosive followed by conversion back to useable forms such as metals or ions.

Similarly, with regards to isotopes, appropriate separations are critical. In most cases isotopes must be relatively pure or highly enriched before they become useful. Current isotope separation technologies are relatively inefficient, capital and labor intensive, and often produced by a limited number of nondomestic suppliers. Most isotopes are produced by separating naturally occurring isotopes or through nuclear reaction, followed by separation as needed. The separation of naturally occurring isotopes is usually performed using gas centrifuge technology, electromagnetic methods, diffusion processes, distillation, ion chromatography, or ion exchange chromatography. Many common isotopes of carbon, oxygen and boron are produced by distillation, chemical exchange, and thermal diffusion. Isotopes can also be enriched by contacting a feed solution containing the isotopes with a cyclic polyether wherein a complex of one isotope is formed with the cyclic polyether, the cyclic polyether complex can be extracted from the feed solution, and the isotope can be subsequently separated from the cyclic polyether. Intermetallic compounds with a CaCu₅ type of crystal structure, particularly LaNiCo and CaNi₅, exhibit high separation factors and fast equilibrium times and therefore are useful for packing a chromatographic hydrogen isotope separation column. The inclusion of an inert metal to dilute the hydride improves performance of the column. A large-scale multi-stage chromatographic separation process run as a secondary process off a hydrogen feed stream from an industrial plant which uses large volumes of hydrogen can produce large quantities of heavy water at an effective cost for use in heavy water reactors.

Many of the stable isotopes used domestically are in short supply or unavailable for future research and applications. Examples of such include, but are not limited to ¹⁵⁷Gd, ⁷⁶Ge, ²⁰⁴pb, ⁹⁶Ru, ¹⁵⁰Sm, ¹⁸¹Ta, ¹⁸⁰W, and ⁵¹V. These isotopes are useful in a variety of applications including neutron capture therapy, toxicology, accelerator target and cross-section measurements, solid state NMR, and other areas of research. Boron-10 has a natural abundance of ˜20% and the rest, 80%, is Boron-11. ¹⁰B is used in control rods of nuclear reactors, breeder-reactors, and other safety devices. It is mainly enriched using a multistage exchange-distillation method where boron trifluoride-dimethyl ether complex is used. Isotope fractionation is achieved through complex distillation at reduced pressure in a tapered columns (cascade). Note that the B-11 enrichment system is a gas-fluid exchange system and involves complex purification processing. The alkaline earth metal strontium (38Sr) has four stable naturally occurring isotopes: ⁸⁴Sr (0.56%), ⁸⁶Sr (9.86%), ⁸⁷Sr (7.0%) and ⁸⁸Sr (82.58%). Its standard atomic weight is 87.62. Some of the important separation methods include use of chloroform solutions with dicyclohexano-18-crown-6, ion exchange resin for sorption of strontium and solubility-based separation (using nitric acid), and precipitation of strontium sulfate. Magnesium isotopes are separated using novel N₃O₂ azo-crown ion exchanger. Such existing chemical ion exchange techniques resulted in separation factors of 1.030, 1.009, and 1.027 for ²⁴mg-²⁵mg, ²⁵mg-²⁶mg, and ²⁴Mg-²⁶Mg combinations, respectively. Zone melting has also been applied for separation of magnesium isotopes. In such a case the coefficient of separation was ˜1.006. Magnesium isotope separation has also been performed using hydrous manganese (IV) oxide. Vacuum arc-based centrifugation has also been used for Mg isotope enrichment. The present invention describes simplified techniques that can achieve similar or even better separation factors, at relatively low cost, and fast processing time.

Boron has two stable isotopes. The isotopic mass of ¹¹B is 11.009, whereas isotopic mass ¹⁰B is 10.012. The spin and parity of these isotopes are different: ¹¹B has 3/2—whereas ¹¹B has 3+. Similarly, calcium also has several stable isotopes (⁴⁰Ca, ⁴²ca , ⁴³Ca , ⁴⁴Ca and ⁴⁶Ca) and other useful radioactive isotopes. Among calcium isotopes, the highest proportion among them was for ⁴⁰Ca (˜96.94%) followed by ⁴⁴Ca (˜2.08%). Naturally occurring iron (26Fe) consists of four stable isotopes: 5.845% of ⁵⁴Fe (possibly radioactive with a half-life over 4.4×10²⁰ years), 91.754% of ⁵⁶Fe, 2.119% of ⁵⁷Fe and 0.286% of ⁵⁸Fe. The isotope ⁵⁶Fe is the isotope with the lowest mass per nucleon, 930.412 MeV/c², though not the isotope with the highest nuclear binding energy per nucleon, which is nickel-62. However, because of the details of how nucleosynthesis works, ⁵⁶Fe is a more common endpoint of fusion chains inside extremely massive stars and is therefore more common in the universe, relative to other metals, including ⁶²Ni, ⁵⁸Fe and ⁶⁰Ni, all of which have a very high binding energy. The isotope ⁵⁷Fe is widely used in Mossbauer spectroscopy and the related nuclear resonance vibrational spectroscopy due to the low natural variation in energy of the 14.4 keV nuclear transition. ⁵⁸Fe is both naturally occurring and can be produced by fission. It has special application in research to develop successful interventions for anemia, conditions for effective iron absorption and excretion, metabolic tracer studies to identify genetic iron control mechanisms, and energy expenditure studies. Naturally occurring gadolinium (64 Gd) is composed of 6 stable isotopes, ¹⁵⁴Gd, ¹⁵⁵Gd, ¹⁵⁶Gd, ¹⁵⁷Gd, ¹⁵⁸Gd and ¹⁶⁰Gd. Copper has two stable isotopes, ⁶³Cu and ⁶⁵Cu. Naturally occurring zirconium (40 Zr) is composed of four stable isotopes (of which one may in the future be found radioactive), and one very long-lived radioisotope (⁹⁶Zr), a primordial nuclide that decays via double beta decay with an observed half-life of 2.0×10¹⁹ years.

### SUMMARY

In the metals processing industry there is a need to separate iron and other dissolved elements, and/or ultrafine particles from solutions. There is also a need in the metals industry to concentrate desired elements or fine particles in processing streams. The presently described separator devices, systems and methods could help to accomplish this due to differences in ion, molecule, and particle properties that can be used as the basis for separation by the forces discussed herein.

In critical materials processing, there is a need to separate elements with similar properties as well as a need to separate elements or ions with different properties. The separator devices, systems and methods discussed herein can facilitate low cost separations for such scenarios. Examples include separating individual rare earth elements by differences in magnetic properties, electrostatic properties, or density. Another example is separating lithium from cobalt or manganese in battery material processing.

Removal of contaminants such as metal ions from water or organic contaminants from blood could be performed using the devices, systems and methods discussed herein.

In an embodiment, a thin fluid layers and streams facilitated, force-based, ion, molecule, and fine particle separator is disclosed. The separator includes at least one support having a surface and defining one or more holes, channels, tubes, or small stream pathways or including one or more collection apparatuses therein. The at least one support includes at least one inclined surface, at least one rotatable cylinder, or at least one channel, tube or small stream pathway. The separator also includes a fluid source that is configured to hold a fluid that includes one or more entities therein. The fluid source is configured to apply a fluid to the surface of the at least one support, channel, tube, etc. The fluid may be dispensed to the surface, channel, tube or small stream pathway or collection thereof during operation, wherein the separator and its surface channels, tubes or small stream pathways are configured and utilized to form a thin fluid layer or stream or sets thereof. The thin fluid layers or streams separator also includes at least one force application device configured to apply a force to a portion of the thin fluid layer or stream or sets thereof, the force including at least one of a centrifugal force, a magnetic force, an electrical force, an electrostatic force, an electrolytic force, a hydrophobic force, a hydrophilic force, or a concentration gradient.

In an exemplary embodiment, a thin fluid layers or streams-based separation device is used for separating atoms, ions, isotopes, molecules or other fine particles from one another. Such a device includes at least one support having a surface, the at least one support including at least one inclined surface, at least one rotatable cylinder, or a channel or collection of channels or fluid pathways. A fluid source is provided, configured to hold a fluid that includes one or more entities to be separated therein, the fluid source being configured to apply a fluid to the surface of the at least one support, wherein the separator is configured to form one or more thin fluid layers or streams on the surface after receiving the fluid from the fluid source. The device also includes at least one force application device configured to apply a desired force to at least a portion of the supported thin fluid layers or streams, the force including at least one of a centrifugal force, a magnetic force, an electric or electrostatic force, an electrolytic force, a concentration gradient, a hydrophobic force or a hydrophilic force. The device also includes one or more collection devices, channels, tubes, or layers positioned to receive fluid enriched or depleted in atoms, ions, isotopes molecules, or other fine particles of the entities to be separated, leaving the region in which the desired force is applied.

A related method for separating atoms, ions, isotopes, molecules, or other fine particles includes providing a separation device as described, and using the thin fluid layers or streams-based separation device to separate select atoms, ions, isotopes, molecules, or fine particles of the entities within the fluid source.

In any of the described embodiments, the at least one support defines one or more holes, channels, tubes or layers therein and the one or more collection devices are positioned adjacent to the one or more holes, channels, tubes, or layers.

In any of the described embodiments, the at least one support includes the at least one rotatable cylinder, wherein rotating the at least one rotatable cylinder with the at least one force application device causes the centrifugal force to be applied to the thin fluid layers or streams.

In any of the described embodiments, the at least one support includes the at least one inclined surface.

In any of the described embodiments, a thickness of the thin fluid layers or streams is selected or controlled by controlling at least one of a flow rate of the fluid dispensed from the fluid source, a viscosity of the fluid, a thickness of one or more thin porous layers or sets of channels, tubes, or streams disposed on the surface, selected properties of the one or more thin porous layers or sets of channels, tubes, or streams, an angle of incline of the surface, a length of the surface, or an angular velocity at which the surface rotates.

In any of the described embodiments, one or more thin porous layers may be disposed on the surface, configured to reduce flow turbulence.

In any of the described embodiments, any such thin porous layers may include chromatography or hydrophilic/hydrophobic separation materials.

In any of the described embodiments, the at least one force application device includes one or more magnets that are configured to apply a magnetic field to the thin fluid layers or streams.

In any of the described embodiments, the at least one force application device includes one or more electrodes configured to apply an electric or electrostatic field to the thin fluid layers or streams.

In any of the described embodiments, the at least one force application device includes one or more electrodes positioned to directly contact the thin fluid layer or stream.

In any of the described embodiments, the at least one force application device includes one or more sequential ring electrodes.

In any of the described embodiments, the at least one force application device is configured to apply an oscillating force.

In any of the described embodiments, the at least one force application device includes at least one carrier or solvent inlet configured to contact the at least one solvent or carrier with the fluid to form a concentration gradient.

In any of the described embodiments, a system may be provided, that includes a plurality of separators, wherein each of the plurality of separators are positioned in cascading sequence to optimize separation of specific entities in the fluid source.

In any of the described embodiments, the fluid can be a liquid or a gas.

In any of the described embodiments, the at least one force application device can include: one or more magnets that are configured to apply the magnetic field to the thin liquid film; one or more electrodes configured to apply the electric or electrostatic field to the thin liquid film; one or more electrodes positioned to directly contact the thin liquid film; one or more sequential ring electrodes; wherein the at least one force application device is configured to apply an oscillating force; or wherein the at least one force application device includes at least one carrier or solvent inlet configured to contact at least one solvent or carrier with the liquid to form a concentration gradient.

In any of the described embodiments, the residence time associated with the presently described separation devices may be relatively short, e.g., no more than about 5 minutes, no more than about 3 minutes, no more than about 1 minute, no more than about 30 seconds, no more than about 10 seconds, no more than about 5 seconds, or no more than about 3 seconds.

In any of the described embodiments, the presently described separation devices may achieve a separation coefficient of at least 1.001, 1.002, 1.003, 1.004, 1.005, 1.006, 1.007, 1.008, 1.009, 1.01, 1.015, 1.02, 1.025, 1.03, 1.035, 1.04, 1.045, 1.05, 1.055, 1.06, 1.065, 1.07, 1.075, 1.08, 1.085, 1.09, 1.095, 1.1, 1.2, 1.3, 1.4, 1.5, 1.6, 1.7, 1.8, 1.9, or 2.0 or greater in short duration, single pass fluid pass separators or much greater in cascading, multiple pass fluid separators, or separator systems. As the working examples show, significant separation can be quickly achieved using the presently described devices, systems, and methods, even for perceivably difficult separations (e.g., separation of isotopes or other entities where mass or other differences are quite small).

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the figures, like reference numerals may be utilized to designate corresponding or similar parts in the various figures, and the various elements depicted are not necessarily drawn to scale.

FIG. 1A is a side perspective view of an exemplary thin fluid layers or streams separator that is a centrifugal device, according to an embodiment.

FIG. 1B is a schematic, magnified cross-sectional diagram of entities in the thin fluid layers or streams of FIG. 1A.

FIG. 2A is a schematic view of a portion of an exemplary thin fluid layers or streams separator, according to an embodiment.

FIG. 2B is a schematic cross-sectional view of an exemplary thin porous layer or stream that is configured to create a chromatography-like separation effect, according to an embodiment.

FIG. 3 is a schematic cross-sectional view of a thin fluid layers or streams separator that is configured to apply a magnetic force to thin fluid layers or streams flowing therein, according to an embodiment.

FIG. 4 is a schematic cross-sectional view of a thin fluid layers or streams separator that is configured to apply an electrostatic force to thin fluid layers or streams flowing therein, according to an embodiment.

FIG. 5 is a cross-sectional view of a thin fluid layers or streams separator, according to an embodiment.

FIGS. 6A, 6B, and 6C are schematic side, top, and bottom views, respectively, of a thin fluid layers or streams separator, according to an embodiment.

FIG. 7 is a schematic cross-sectional view of a thin fluid layers or streams separator that includes an inclined surface, according to an embodiment.

FIG. 8 is a cross-sectional schematic view of a thin fluid layers or streams separator that uses concentration gradients to separate entities, for example, based on the mass of the isotopes of an entity, according to an embodiment.

FIG. 9 is a cross-sectional schematic view of a thin fluid layers or streams separator that uses concentration gradients and temperature to separate entities, according to an embodiment.

FIG. 10 is a cross-sectional schematic of a thin fluid layers or streams separator, according to an embodiment.

FIG. 11 is a cross-sectional schematic view of a system that includes a plurality of thin fluid layers or streams separators connected in series, according to an embodiment.

FIG. 12 includes side and top schematic views of a thin fluid layers or streams separator that is a field-flow fractionation device, according to an embodiment.

FIG. 13 schematically illustrates the thin fluid layers or streams separator of working example 1.

FIG. 14 schematically illustrates the thin fluid layers or streams separator of working example 2.

FIGS. 15-17 are graphs showing the results of separating a solution using the thin fluid layers or streams separator of working example 2.

FIG. 18 shows a portion of the thin fluid layers or streams separator of working example 3.

FIGS. 19 and 20 are graphs showing the results of separating a solution using the thin fluid layers or streams separator of working example 3.

FIG. 21 is a graph showing the results of the analysis of the collected fluid from the second solution using the thin fluid separator of working example 4.

FIGS. 22A-22B schematically illustrate the thin fluid layers or streams separator of working example 5 that included an inclined surface.

FIGS. 23 and 24 are graphs that illustrates changes in the pH and Eh, respectively, of the collected solution from the thin fluid layers or streams separator of working example 5.

FIG. 25 is a graph illustrating the concentration of the collected solutions from the thin fluid layers or streams separator of working example 5 versus conductivity for the NaCl solution and the treated desalinated solution.

FIG. 26 is a graph illustrating the ratio of boron 11 to boron 10 in the collected solution detected using a multi-collector ICPMS.

FIG. 27 schematically illustrates a thin fluid layers or streams separator, according to an embodiment.

FIG. 28 schematically illustrates the general principal of operation, according to an embodiment.

FIG. 29 schematically illustrates an embodiment with microchannels formed by overlaying rows of wires in two layers that are offset by an angle.

FIG. 30 schematically illustrates an exemplary multistage centrifugal integrated enrichment unit, according to an embodiment.

### DETAILED DESCRIPTION

### I. Introduction

The present disclosure describes separators that employ thin fluid layers or streams that are configured to utilize such thin fluid layers or streams, multi-port collections, and, when appropriate, one or more forces to separate and recover elements, molecules, ions, isotopes, and/or particles (“entities”) in diverse applications using a variety of forces. The thin fluid layers or streams separators disclosed herein include at least one support having a surface. The at least one support may include an inclined surface (e.g., inclined flat plate(s)), one or more rotatable cylinders (e.g., centrifugal devices), or one or more channels, collections of channels, or fluid pathways, e.g., channels, streams, tubes or a hollowed structure (e.g., a pipe). The fluid separators may allow for the creation of a thin fluid flowing layer or stream or sets of the same on the surface of the support by dispensing a fluid onto the surface, channels, tubes, or sets thereof. The fluid dispensed onto the surface, channels, tubes, or sets thereof, and by extension the thin fluid layer or stream itself, may include entities with different properties that can be separated based on differences in those properties such as density, charge, conductivity, mobility, hydrophobicity/hydrophilicity, polarity, electrochemical potential, size, mass, etc. Depending on the properties of the entities to be separated, the thin fluid layers or streams separators disclosed herein can include at least one force application device configured to subject at least a portion of the thin fluid layer(s) or stream(s) to a large force gradient using at least one of a magnetic force, an electric and/or electrostatic force, a centrifugal force, an electrolytic force, an oscillating force, a concentration gradient, or a hydrophobic force or a hydrophilic force. In an example, the thin fluid layers or streams separator may form the thin fluid layers or streams due to the force (e.g., centrifugal force) applied to the fluid on the surface of the support and/or at least one thin porous layer or sets of channels, tubes, or streams that is disposed on the surface of the support. Such thin fluid layers or streams separators may have short residence times for separation (e.g., less than 30 seconds), and in some cases can efficiently separate more dense metal ions, metal bearing compounds, or isotopes from lighter ones. The separators disclosed herein may also include one or more collection devices to collect separated or partially separated products. Such separators may be operated in series, to further enhance the separation.

In an embodiment, the separators may include one or more thin porous layers or sets of channels, tubes, or streams layers or streams disposed on the surface of the at least one support comprising one or more fibers that are configured to contain the fluid and prevent or minimize fluid mixing between the layers while fluid flows within each layer or stream, which may make the separation much more efficient than in existing technologies, which do not have the one or more thin porous layers or sets of channels, tubes, or streams or streams to prevent or minimize mixing of adjacent streams.

During operation, the thin fluid layer separators may form a thin fluid layer or stream on the support surface with controlled thickness and minimized advection that is combined with forces such as one or more of magnetic, centrifugal, or electrostatic forces or concentration gradients to facilitate low cost, rapid, efficient separation of the entities in the thin fluid layers or streams. For example, the thin fluid layers, tubes, channels, or streams may have a thickness of a few micrometers to a few millimeters, such as about 2 mm to about 5 mm, about 1 mm to about 2 mm, about 750 μm to about 1.5 mm, about 600 μm to about 1 mm, about 500 μm to about 700 μm, about 400 μm to about 600 μm, about 300 μm to about 500 μm, about 200 μm to about 400 μm, about 150 μm to about 300 μm, about 100 μm to about 200 μm, about 75 μm to about 150 μm, about 50 μm to about 100 μm, about 25 μm to about 75 μm, about 10 μm to about 50 μm, about 5 μm to about 25 μm, or about 1 μm to about 10 μm. The control of the thickness of the thin layer across which the separation takes place makes the separation much more rapid than other technologies that use such forces. The layer or stream thickness is primarily controlled by flow rate, viscosity, porous liner thickness, porous liner properties, angle of incline, channel size, wire size, tube size, fiber size, length, and/or angular velocity. It is noted that any of the thin porous layers or channels, tubes, or fibers, individual and/or collectively, may exhibit any of the same thicknesses as the thin fluid layers or streams provided above.

In an embodiment, the thin fluid layers or streams separators disclosed herein may not require pressurized flow. Indeed, in an embodiment, no pressure for flow is applied. In an embodiment, the thin fluid layers or streams separators disclosed herein are scalable in design. In an embodiment, the thin fluid layers or streams separators disclosed herein may be used in systems that include cascades of the thin fluid layers, tubes, channels, or streams separators or a plurality of the thin fluid layers, tubes, channels, or streams separators in series to allow for multiple product streams at various stages of separation to optimize separation of specific products. In an embodiment, the thin fluid layer separators disclosed herein consume less than about 0.75 kilowatt hours per liter of fluid processed (kWhr/l), such as less than about 1×10⁻⁵ kWhr/l, less than about 2×10⁻⁵ kWhr/l, less than about 3×10⁵ kWhr/l, less than about 5×10⁻⁵ kWhr/l, less than about 0.02 kWhr/l, less than about 0.05 kWhr/l, less than about 0.1 kWhr/l, less than about 0.2 kWhr/l, less than about 0.5 kWhr/l, or in ranges of about 1×10⁻⁵ kWhr/l to about 3×10⁻⁵ kWhr/l, about 2×10⁻⁵ kWhr/l to about 5×10⁻⁵ kWhr/l, about 4×10⁻⁵ kWhr/l to about 1×10⁻⁴ kWhr/l, about 1×10⁻⁴ kWhr/l to about 1×10⁻³ kWhr/l, 1×10⁻³ kWhr/l to about 0.01 kWhr/l, about 0.01 kWhr/l to about 0.02 kWhr/l, about 0.015 kWhr/l to about 0.04 kWhr/l, about 0.02 kWhr/l to about 0.06 kWhr/l, about 0.05 kWhr/l to about 0.1 kWhr/l, about 0.08 kWhr/l to about 0.15 kWhr/l, about 0.1 kWhr/l to about 0.2 kWhr/l, about 0.15 kWhr/l to about 0.3 kWhr/l, about 0.2 kWhr/l to about 0.4 kWhr/l, about 0.3 kWhr/l to about 0.5 kWhr/l, about 0.4 kWhr/l to about 0.6 kWhr/l, or about 0.5 kWhr/l to about 0.75 kWhr/l. In an embodiment, the electrical energy per liter of fluid that the thin fluid layers or streams separator requires to operate may depend on whether the thin fluid layers or streams separator includes a rotatable cylinder or an inclined surface. For example, a rotatable cylinder may require more electrical energy per liter (e.g., 0.01 kWhr/l to about 0.75 kWhr/l) than an inclined surface or crossing sets of channels (e.g., less than 0.1 kWhr/l). In an embodiment, the electrical energy per liter of fluid processed that the thin fluid layers or streams separator requires to operate may depend on the size of the thin fluid layers or streams separator since increasing the size of the thin fluid layers or streams separator (e.g., increase the number of liters per hour that the thin fluid layers or streams separator can receive) may decrease the electrical energy per liter needed to operate the separator.

In an embodiment, the thin fluid layers or streams separators disclosed herein may be configured to be used with any suitable fluid, such as water, ionic fluids, aqueous fluids, organic fluids, biological fluids, human body fluids, gases, molten salts, molten metals, molten slag, or molten glass. In an embodiment, the thin fluid layers or streams separators disclosed herein may be used to separate any suitable entities, such as, but not limited to at least one of lithium, sodium, potassium, magnesium, cerium, dysprosium, neodymium, lanthanum, magnesium, erbium, iron, copper, thallium, technetium, indium, xenon, iodine, yttrium, strontium, lutetium, rhenium, samarium, fluorine, gallium, zirconium, hydrogen, potassium, sulfur, chromium, selenium, carbon, plutonium, curium, americium, cerium, californium, lithium, helium, nickel, boron, vanadium, tungsten, tantalum, ruthenium, lead, germanium, gadolinium, zinc, or compounds, ions or isotopes thereof. In an embodiment, the thin fluid layers and streams separators disclosed herein may be configured to be used with fluids that have surfactants or other additives included therein.

Applications of the thin fluid layers or streams separators disclosed herein may include desalination, water purification, chemical concentration, separation of entities, separation of isotopes, medicinal separations, biological matter separations, and separation of different types of very fine particles based on differences in densities, mobilities, solvent interactions, charge, electrochemical potential, and magnetic susceptibilities.

### II. Exemplary Separators and Methods

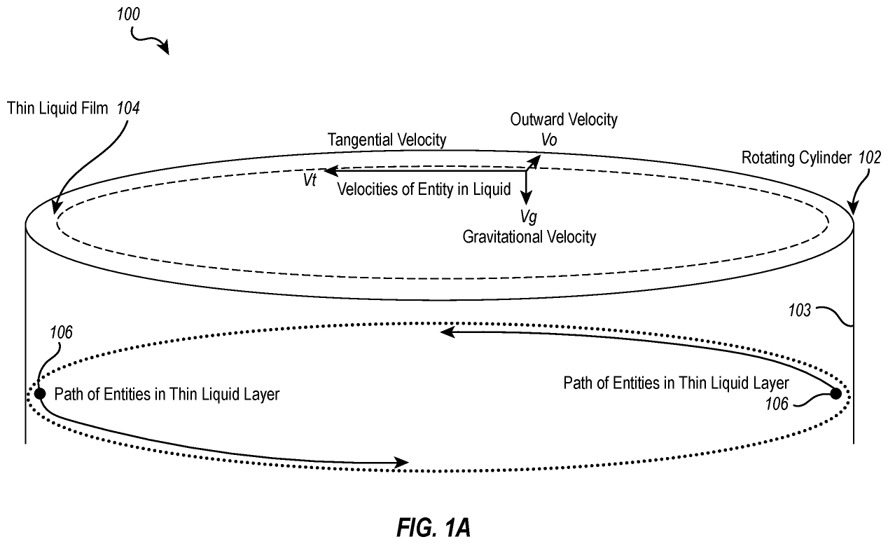

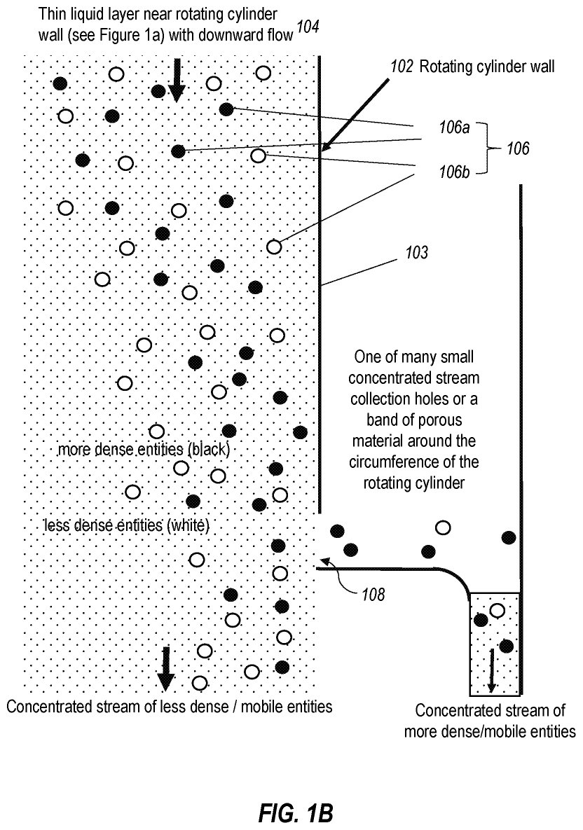

In an embodiment, the thin fluid layers and streams separators disclosed herein may include a centrifugal device. (e.g., applies at least a centrifugal force to the thin fluid layers and streams) FIG. 1A is a side perspective view of an exemplary thin fluid layers or streams separator 100 that is configured as a centrifugal device. The thin fluid layers or streams separator 100 includes at least one support that is a rotatable cylinder 102. The rotatable cylinder 102 includes a surface 103 (e.g., an inner surface) that is configured to receive a fluid and have thin fluid layers or streams 104 formed thereon. The thin fluid layers or streams 104 may include at least one entity 106 (e.g., an ion, molecule, isotope, or very fine particle; shown schematically as black circles). The rotatable cylinder 102 may exhibit a length of about 3 inches to about 100 feet (e.g., about 6 inches to about 10 feet, about 1 foot to about 7 feet, or about 10 feet) and a diameter of about 0.1 inch to about 30 feet (e.g., about 0.1 inches to about 5 inches or about 3 inches to about 12 inches). The thin fluid layers or streams separator 100 also includes at least one force application device (not shown) coupled to the rotatable cylinder 102 that is configured to rotate the rotatable cylinder thereby providing a centrifugal force to the thin fluid layers or streams 104. FIG. 1A also illustrates the velocity vectors (e.g., tangential velocity Vₜ, outward velocity V₀, and gravitational velocity V_{g}) influencing motion of entity 106 as the entity 106 circulates within the thin fluid layers or streams 104 as the thin fluid layers or streams 104 spin around with the rotatable cylinder 102. The use of centrifugal forces to facilitate or augment separation of the entities 106 is based on density and mobility.

The centrifugal force F exerted on the entity 106 in a centrifugal device is shown in equation (1),

F=mrω² (1)

where m is the mass of the entity 106, r is the radius from the center of the rotatable cylinder 102 at the point of force measurement, and ω is the angular velocity. The centrifugal force may lead to acceleration of the entity 106 in the thin fluid layers or streams 104 and a resultant velocity towards the rotatable cylinder 102. The entity 102 may also have a relatively high velocity that is tangential to the rotatable cylinder 102 as well as a downward velocity due to gravity if the rotatable cylinder 102 is vertical. The present embodiment differ from gas centrifuge separations, in that no expensive high speed centrifuge is required. Where a centrifugal force is applied, the employed rotational speed may be far slower than typical in high speed gas centrifuge separations (e.g., less than 10,000 RPM, less than 5,000 RPM, or less than 3,000 RPM.

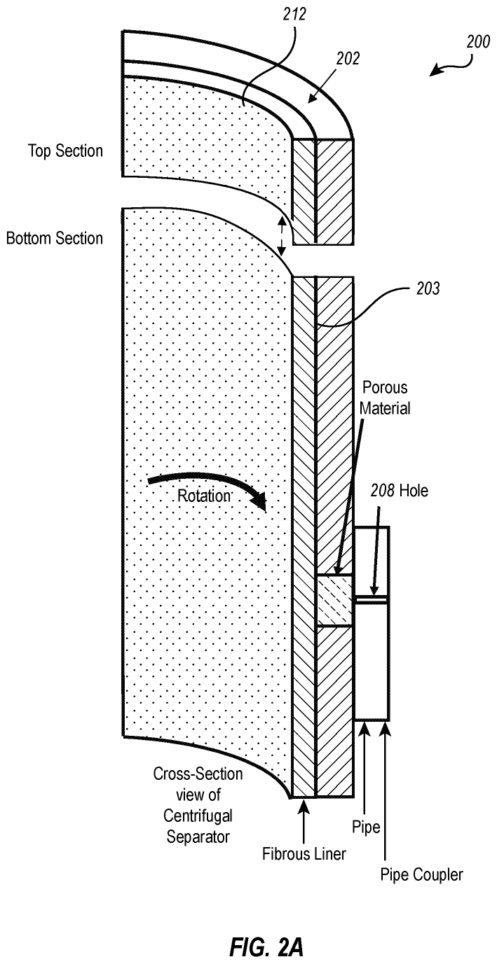

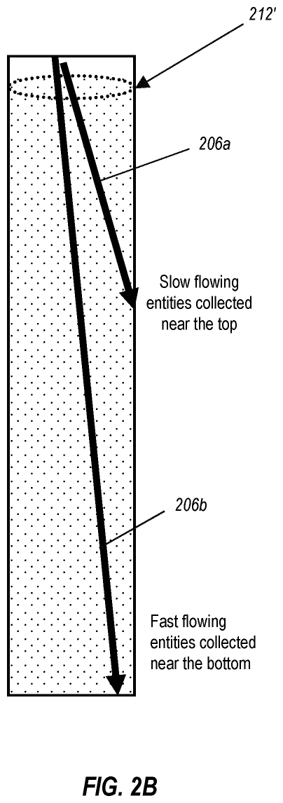

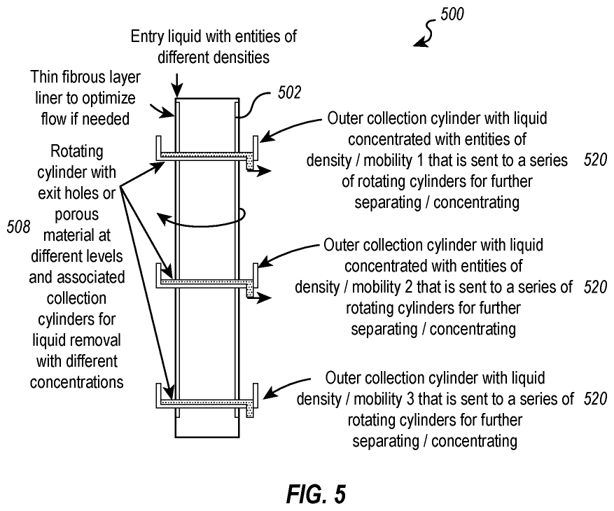

The centrifugal field allows more dense and mobile entities to be separated from less dense and less mobile entities. For example, FIG. 1B is a schematic, magnified cross-sectional diagram of entities 106 in the thin fluid layers or streams 104 of FIG. 1A. The centrifugal field creates the thin layers or streams 104 and the thin layers or streams 104 enables the separation by the centrifugal field to occur rapidly. FIG. 1B illustrates that more dense and mobile entities 106a move toward the wall of the rotatable cylinder 102 more completely and rapidly than less dense and mobile entities 106b due to the centrifugal force that exerts a greater force on the denser entities 106a. Therefore, the more dense and mobile particles 106a are concentrated near the wall of the rotatable cylinder 102 and can be collected in fluid exiting through one or more holes 108 in the wall of the rotatable cylinder 102 at a higher concentration than in the starting bulk solution or other fluid. The thickness of the thin fluid layers or streams 104 is controlled by at least the rotational speed and, if included, the thickness of one or more porous layers or channels, tubes, or streams (e.g., see FIG. 2A) positioned adjacent to the rotatable cylinder 102. The separation is rapid because the force acts across the very thin fluid layers or streams 104, which makes the distance of movement of entities 106 very short, and the corresponding process rapid. Therefore, it is possible to separate more dense and mobile entities 106a in the thin layers or streams 104 in a short period of time. It is also possible to sequentially remove the entities 106 at different locations along the length of a rotatable cylinder as illustrated in FIG. 5 through small holes or through porous media, for further concentration or other processing.

In embodiments where the only applied force for separation is the centrifugal force, the time for separation may depend on the centrifugal force, which, as previously discussed, may be related to the rotational velocity squared and the diameter of the cylinder as well as by the flow rate of thin fluid layers or streams 104 which influences the thickness of the thin fluid layers or streams 104 and the thin fluid layers or streams 104 downward velocity (assuming the rotating cylinder is oriented with the axis of rotation oriented vertically). The time for separation also may depend on any other forces that are applied (e.g., magnetic, electric, etc.) as well. The viscosity of the thin fluid layers or streams 104, which may be strongly influenced by temperature, may also affect the time for separation. The time for separation may also be influenced by the location of the collection port (e.g., 108) relative to the input of fluid.

In an embodiment, the thin fluid layers or streams separator 100 may rotate at a speed of greater than 0 RPM to about 5000 RPM, such as in ranges of greater than 0 RPM to about 1800 RPM, about 500 RPM to about 1500 RPM, about 1000 to about 2000 RPM, or about 1500 RPM to about 3000 RPM. Those of skill in the art will appreciate that such speeds are significantly slower than typically required in high speed centrifuges, for gas centrifuge separations. The slower speeds and simpler structure results in a system that is far less expensive to provide and operate.

FIG. 2A is a schematic view of a portion of a thin fluid layers or streams separator 200, according to an embodiment. Except as otherwise disclosed herein, the thin fluid layers or streams separator 200 may be the same or substantially similar to any of the thin fluid layers or streams separators disclosed herein (e.g., separator 100). For example, the thin fluid layers or streams separator 200 may include a rotatable cylinder 202 that defines one or more holes therethrough 208.

The thin fluid layers or streams separator 200 may also include one or more thin porous layers and streams 212 (e.g., thin porous liners, coatings, and/or surfaces) disposed on the inner surface 203 of the rotatable cylinder 202 to create, maintain, and/or stabilize one or more thin fluid layers or streams, in the thin porous layer 212, flowing therein. In an example, the thin porous layers and streams 212 may be made using fibrous material (e.g., large thin sheets of lint free KIM wipes, thin porous fibers or networks of fibers, thin porous ceramics, thin porous metals or other suitable porous materials that can withstand the expected environment) that line the inner wall surface 203 of the rotatable cylinder 202. The thin porous layers and streams 212 may be inserted into the thin fluid layers or streams separator 200 to mitigate potential turbulence in the thin fluid layers or streams. For instance, not wishing to be bound by theory, it is currently believed that, as the speed of the rotation increases, there may be more potential for fluid flow in the thin fluid layers or streams to become somewhat turbulent. The turbulence may cause mixing which, in turn, may make the separation of the entities in the thin fluid layers or streams more difficult and less efficient. Because the thin porous layers 212 holds the thin fluid layers or streams by capillary forces, the thin fluid layers or streams are not as free to flow and form turbulent regions or wavefronts. Thus, the thin porous layers 212 may hold the thin fluid layers or streams to the wall of the rotatable cylinder 202 and may allow the centrifugal forces to perform the separation through the thin porous layers 212 towards the wall of the rotatable cylinder 202 as the thin fluid flows down through the rotatable cylinder 202. Also, the thin porous layers 212 may inhibit turbulent mixing. It is noted that the thin porous layers 212 are optional and may be omitted from the thin fluid layers or streams separator 200, although when included, they provide advantages noted above.

In an embodiment, the thin porous layers and streams 212 can be selected to create a chromatography-like separation effect. The use of the thin porous layers and streams 212 may provide an additional opportunity for separation by using porous media with varying properties. For example, thin porous layers and streams and streams 212 that have properties that are similar to those of a chromatography column may enhance the separation of entities that are attracted to the thin porous layers and streams 212. In such an example, thin porous layers and streams or sets of channels, tubes, or streams 212 may facilitate separation of entities based on the combination of attraction to the thin porous layers and streams 212 and the properties of the entities undergoing separation. For instance, FIG. 2B is a schematic cross-sectional view of a thin porous layer 212′ that is configured to create a chromatography-like separation effect, according to an embodiment. As shown in FIG. 2B, the thin porous layers or sets of channels, tubes, or streams 212′ facilitates separation since slow moving entities 206a (path of the slow moving entities 206a is shown schematically with an arrow) may be collected near the top of the thin porous layer 212′ while faster flowing entities 206b (path of the fast moving entities 206b is shown schematically with an arrow) may be collected near the bottom of the thin porous layers or sets of channels, tubes, or streams 212′.

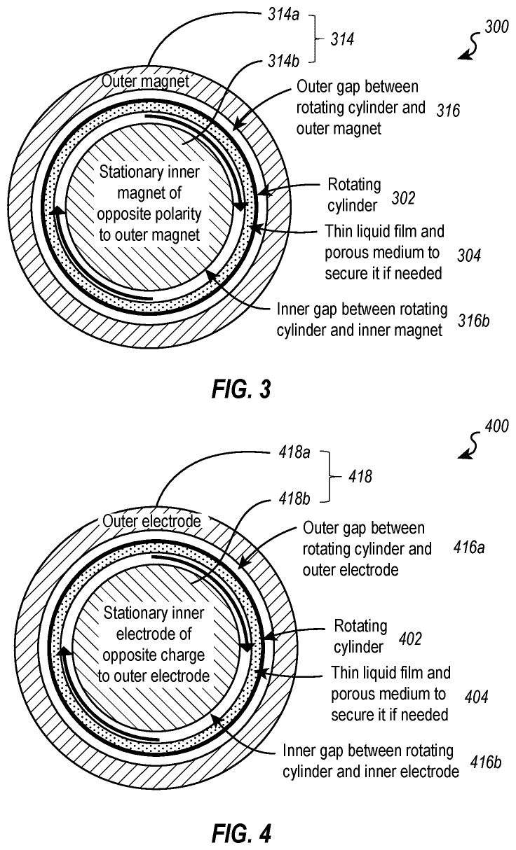

FIG. 3 is a schematic cross-sectional view of a thin fluid layers and streams separator 300 that is configured to apply a magnetic force to a thin fluid layer and stream 304 flowing therein, according to an embodiment. Except as otherwise disclosed herein, the thin fluid layers and streams separator 300 may be the same or substantially similar to any of the thin fluid layers and streams separators disclosed herein. For example, the thin fluid layers and streams separator 300 may include a rotatable cylinder 302.

The at least one force application device of the thin fluid layers and streams separator 300 includes one or more magnets 314 that are configured to apply a magnetic field to the thin fluid layers and streams 304. Applying the magnetic field to the thin fluid layers and streams 304 may enhance separation of entities in the thin fluid layers and streams 304. The applied magnetic field may improve and speed up the separation as well as decrease energy needed to separate the entities, and may facilitate or augment separation of entities based on magnetic susceptibility and mobility.

In an example, not wishing to be bound by theory, the entities in the thin fluid layers and streams may act as charged particles (e.g., ions). A charged particle moving perpendicular to a magnetic field experiences a force that causes the circular motion of the particle with radius of trajectory ‘r’ as shown in equation 2:

$$r = \frac{mv}{qB} \qquad ( 2 )$$

where ‘m’ is the mass, ‘q’ is the charge, and is the velocity of particle. ‘B’ is the applied magnetic field.

Thus, in the case of constant charge, velocity, and applied magnetic field, the radius of the path of the charged entities in the thin fluid layers and streams separator will depend on the mass of the entity. In other words, entities with higher mass will experience more deflection than lighter entities. In other words, while applying the magnetic field, the flow of the entities in the thin fluid layers and streams separators may depend on mass and charge. In such cases, more dense entities in the thin fluid layers and streams can be separated from the lighter entities.

The magnet 314 may include any suitable magnet. In an embodiment, the magnet 314 includes one or more permanent magnets, such as permanent rare earth magnets. In an embodiment, the magnet 314 includes one or more electromagnetics. In an embodiment, the magnet 314 may run substantially all of or only a portion of the length of the rotatable cylinder 302. In an embodiment, the magnets 314 are configured to be adjustable and/or tunable thereby allowing the magnetic field to be selected to optimize separations.

In an embodiment, the magnet 314 includes a plurality of magnets, such as an outer magnet 314a and an inner magnet 314b, e.g., with opposing polarities. In an embodiment, there is a gap 316a between the outer magnet 314a and the rotatable cylinder 302 such that the inner magnet 314a does not inhibit rotation of the rotatable cylinder 302. In an embodiment, there is a gap 316b between the inner magnet 314b and the thin fluid layers and streams 304 such that the inner magnet 314b does not inhibit the flow of the thin fluid layers and streams 304.

FIG. 4 is a schematic cross-sectional view of a thin fluid layers and streams separator 400 that is configured to apply an electrical and/or electrostatic field to a thin fluid layer and stream 404 flowing therein, according to an embodiment. Except as otherwise disclosed herein, the thin fluid layers and streams separator 400 may be the same or substantially similar to any of the thin fluid layers and streams separators disclosed herein. For example, the thin fluid layers and streams separator 400 may include a rotatable cylinder 402.

The at least one force application device of the thin fluid layers and streams separator 400 includes one or more electrodes 418 that are configured to apply an electric and/or electrostatic field to the thin fluid layers and streams 404. The one or more electrodes 418 may include an outer electrode 418a and an inner electrode 418b having opposing polarities. Applying the electric and/or electrostatic field to the thin fluid layers and streams 404 may enhance separation of the thin fluid layers and streams 404. For example, while applying the electric and/or electrostatic field, the flow of entities in the thin fluid layers and streams separator may depend on the charge of the entities (e.g., the effect of the charge of the entities on separation of the entities may be more pronounced with the electric and/or electrostatic field than with a magnetic field). The applied electric and/or electrostatic field may improve and speed up the separation as well as decrease energy (e.g., rotational energy) need to separate the entities, and facilitate or augment separation of entities based on charge and mobility. For example, the use of permanent or oscillating electrodes in the center (e.g., the inner electrode 418a) and around the perimeter (e.g., outer electrode 418b) with opposite polarities can augment the centrifugal force to improve the separation of charged entities. These forces can be oscillated to resonant frequencies of desired target entities in the fluid to be concentrated (or depleted).

In an embodiment, there is a gap 416a between the outer electrode 418a and the rotatable cylinder 402 such that the outer electrode 418a does not inhibit rotation of the rotatable cylinder 402. In an embodiment, there is a gap 416b between the inner electrode 418b and the thin fluid layers and streams 404 such that the inner electrode 418b does not inhibit the flow of the thin fluid layers and streams 404.

It is noted that any of the thin fluid layers and streams separators disclosed herein may include one or more additional force application devices that are configured to apply forces to the thin fluid layers and streams, where such forces may be other than or in addition to centrifugal forces, magnetic forces, and/or electrostatic forces. For example, any of the thin fluid layers and streams separators disclosed herein may include a force application device that uses electrolytic forces to separate entities in a thin fluid layer and stream. In such an example, the force application device may include one or more electrodes in contact with the thin fluid layers and streams and the potential between the electrodes may be configured to reduce or electrodeposit desired, more dense, more charged, and/or more magnetically susceptible entities. The electrodes that are in contact with the thin fluid layers and streams may include interior ring electrodes on the interior wall of the rotatable cylinder. The interior ring electrodes may exhibit electrochemical potential that can be adjusted to harvest entities in a desired sequence.

FIG. 5 is a cross sectional elevation view of a thin fluid layers and streams separator 500, according to an embodiment. Except as otherwise disclosed herein, the thin fluid layers and streams separator 500 may be the same or substantially similar to any of the thin fluid layers and streams separators disclosed herein. The thin fluid layers and streams separator 500 includes a rotatable cylinder 502 that exhibits a constant diameter along a length thereof. The thin fluid layers and streams separator 500 includes a plurality of rows of holes 508 in the rotatable cylinder 502 at different distances from a top (or bottom) of the rotatable cylinder 502. Each of the holes 508 may have a fluid flowing therethrough with a different concentration of target entities depending on the density and/or mobility of the entities in the thin fluid layers and streams separator 500. Each row of holes 508 may be associated with an outer collection cylinder 520 that is configured to collect the fluid exiting the holes 508. As shown, a different collection cylinder 520 may be provided to collect fluid exiting from each different row of holes 508.

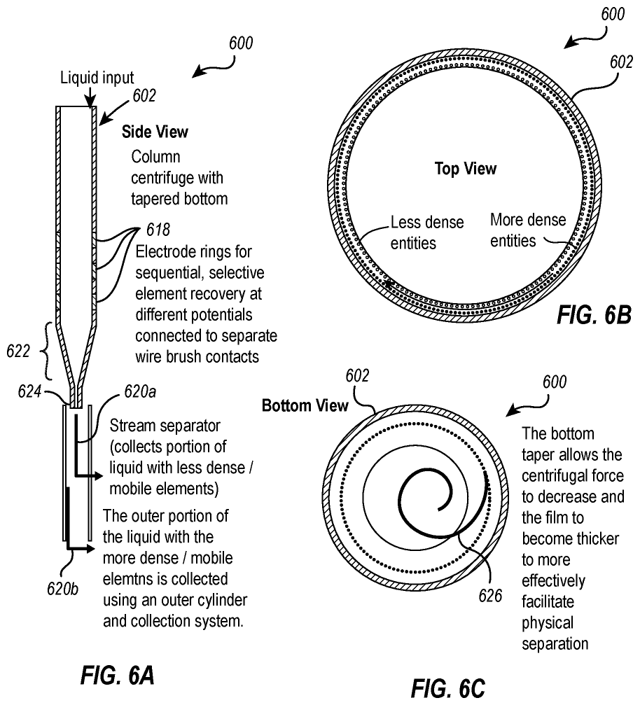

FIGS. 6A, 6B, and 6C are schematic side, top, and bottom views, respectively, of a thin fluid layers and streams separator 600, according to an embodiment. Except as otherwise disclosed herein, the thin fluid layers and streams separator 600 may be the same as or substantially similar to any of the thin fluid layers and streams separators disclosed herein. For example, the thin fluid layers and streams separator 600 includes a rotatable cylinder 602 and one or more electrode rings 618.

The rotatable cylinder 602 includes a tapering section 622 near a bottom 624 thereof. The tapered section 622 causes the centrifugal force applied to the thin fluid layers and streams in this region to decrease which, in turn, causes the thin fluid layers and streams to increase a thickness thereof. The thin fluid layers and streams separator 600 may also include a physical baffle or other separator 626 adjacent to the tapered section 622. As shown, separator 626 may have a spiral configuration. Since the fluid layers and streams is thicker at and/or below the tapered section 622, the physical separator 626 may physically separate an outer portion of the fluid layers and streams from an inner portion of the fluid layers and streams. Separating the outer and inner portion of the fluid layers and streams may more effectively facilitate physical separation of the entities therein, since the outer portion of the fluid layers and streams may have a higher concentration of more dense entities than the inner portion. The thin fluid layers and streams separator 600 may include a first collection device 620a that is configured to collect fluid from the inner portion of the fluid layers and streams and a second collection device 620b that is configured to collect fluid from the outer portion of the fluid layers and streams.

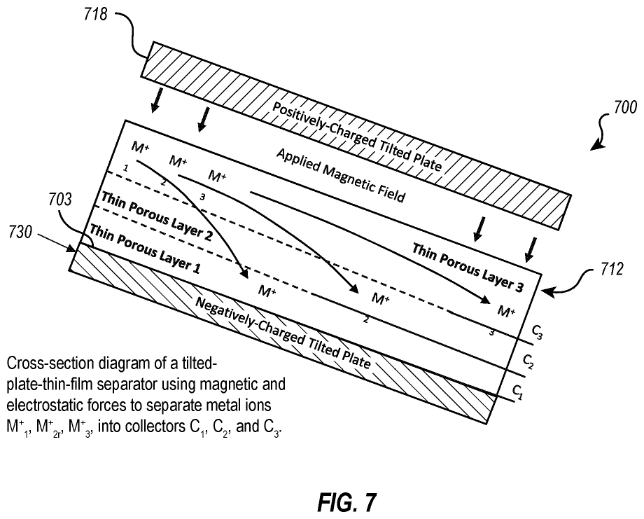

The thin fluid separators disclosed herein may include at least one support that includes an inclined surface, e.g., instead of a rotatable cylinder (e.g., centrifugal device). FIG. 7 is a schematic cross-sectional view of a thin fluid layers and streams separator 700 that includes an inclined surface, according to an embodiment. The thin fluid layers and streams separator 700 includes at least one inclined surface 730 (e.g., tilted plate) that is obliquely angled relative to gravity (e.g., vertical). A thin fluid layer(s) and stream(s) in the thin porous layers 712 flows down surface 703 of the inclined surface 730.

The thin fluid layer separator 700 is shown as including at least one force application device configured to apply additional forces (in addition to gravity) to the thin fluid layers and streams similar to the other thin fluid layers and streams separators disclosed herein. In an example, the force application device may include electrodes that are configured to apply an electric and/or electrostatic field to the thin fluid layers and streams. The electrodes may include a top electrode 718 and an opposing bottom electrode that can be integrally formed with the inclined plate 730 (as illustrated) or provided distinct from the inclined plate 730. In an example, the force application device of the thin fluid layers and streams separator 700 may include magnets in place of or in addition to the illustrated electrodes that apply a magnetic force to the thin fluid layers and streams. In an example, the thin fluid layers and streams separator 700 may also include one or more thin porous layers or sets of channels, tubes, or streams 712 disposed on a surface of the inclined surface 730 to inhibit turbulence in the thin fluid layer. The one or more thin porous layers or sets of channels, tubes, or streams 712 may include a single thin porous layer or sets of channels, tubes, or streams 712 or a plurality of thin porous layers or sets of channels, tubes, or streams 712 that may each affect how the entities flow therein.

By way of example, the incline of the surface (e.g., surface 703) may range from 5° to 85°, from 10° to 70°, from 20° to 60°, or from 30° to 50°, relative to a 90° incline being vertical.

In an embodiment, the thin fluid layers and streams separator 700 may operate in a way that is similar to a mass spectrometer with the additional benefit of enhancing ionic separations based on charge and mobility of ions in solution. In mass spectrometers, atoms are ionized to allow them to be accelerated by a voltage gradient to move them through a magnetic field, whereas the entities flowing through the thin fluid layers and streams separator 700 may be moving with the flowing fluid through the magnetic field as well as an electric and/or electrostatic field. In mass spectrometers the ions in a vacuum are displaced by approximately 1 cm in the device. In the thin fluid layers and streams separator 700, the desired path length is related to the thickness of the thin fluid layers and streams, which is on the order of 100 μm (far smaller than displacement in a mass spectrometer).

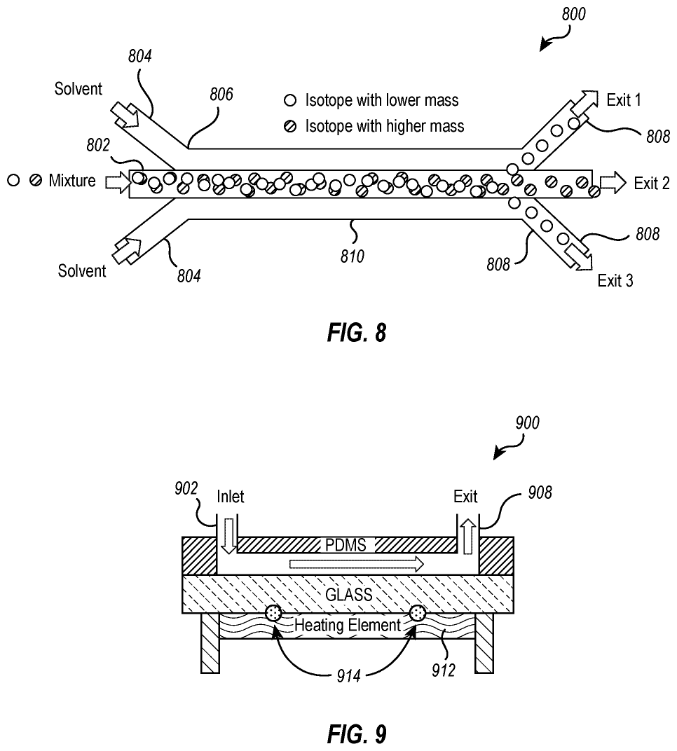

As previously discussed, entities (e.g., elements, molecules, ions, isotopes, and particles with different properties) can be separated based on differences in properties such as density, charge, conductivity, electrochemical potential, size, mass, etc. In some embodiments, the fluid separators disclosed here may use transverse diffusion across a laminar stream due to concentration gradients and the use of thin layers and streams instead of or in addition to separating based on differences in properties such as density, charge, conductivity, electrochemical potential, size, mass, etc. FIG. 8 is a cross-sectional schematic of a thin fluid layers and streams separator 800 that uses concentration gradients to separate entities, for example, based on the mass of the isotopes of an entity, according to an embodiment. Except as otherwise disclosed herein, the thin fluid layers and streams separator 800 may be the same as or substantially similar to any of the separation devices disclosed herein. The thin fluid layers and streams separator 800 is an example of a laminar flow separation device. The thin fluid layers and streams separator 800 begins with carrier or solvent (hereafter solvent for simplicity) and a blend of the entities with various masses. At the point when the blend of the entities (e.g., a mixture of two different isotopes) are injected through the focal passage 802, the blend of entities meets the solvent stream infused from the side passages 804. The side passages 804 act as a force application device since the blend of entities meeting the solvent stream forms a concentration gradient that causes separation of the entities. For example, an instantaneous laminar stream formation occurs at the intersection 806 and the steady interface between the arrangement containing the blend of the entities (e.g., isotopes in ionic form) and the solvent is produced. In this interface of three solution layers, dispersion happens because of the concentration gradient (generated due to the difference in concentrations). At that point, the lighter entities (e.g., lighter isotope) diffuses through the interface more rapidly than the heavier entities (e.g., heavier isotope). Thus, just the lighter entities can be gathered along the edge outlets 808 by controlling the inlet stream flow rates. Such separation of the entities from the blend of entities can be achieved basically by utilizing the dynamic nature of the entities with various diffusivities along the transverse direction to the channel stream 810. The speed of the separation is proportional to the thickness of the layer or stream. Therefore, the layers and streams need to be thin, as described herein.

The thin fluid layers and streams separator 800 may be formed using any suitable technique. In an embodiment, the microfluidic separation channel 810 may be created by joining a patterned polydimethylsiloxane (PDMS) and a transparent slide glass after appropriate treatment such as oxygen plasma. First, a thin layer of SU-8 or other photoresist may be spin-coated on a smooth silicon wafer, and photolithography will be conducted to pattern the microfluidic separation channel. Then, the PDMS may be poured onto the patterned SU-8 mold and cured at designated temperature for 2 hours. The PDMS may be relieved from the SU-8 mold to create the pattern of the microfluidic separation channel on the PDMS. Finally, the patterned PDMS layer may be bonded with the glass substrate after treating the surface with oxygen plasma for a few minutes (e.g., 1-5 minutes).

The thickness of the layer can be controlled by a combination of a porous support media and flow velocity. The thin, porous structure is generally needed to control layer thickness, stabilize laminar flow, and prevent solution mixing that would otherwise remix the entities separated by the application of the separation force. The thin fluid layers and streams separator 800 may be or include what is generally known as an H-filter or H-sensor due to its geometrical structure. A buffer fluid with two entities (e.g., isotope with lower mass and isotope with higher mass) are circulated through one inlet 802 of the H-filter. A pure buffer fluid is injected at the other inlet 804. The two fluids are forced into a junction (e.g., T or Y-junction). The width of the channels may shrink beyond the intersection 806. The two fluids move side by side along the primary channel 810. Due to the laminar nature of flow in microfluidic channels 810, turbulent mixing is not present and the only mixing is through diffusion. One of the two entities, being lighter, has a larger diffusion constant than the other entity and will start to diffuse into the pure buffer fluid more rapidly than the heavier entity. Design of the H-filter should be such that the length of the primary channel is long enough to allow sufficient time for the lighter entity to diffuse significantly more than the heavier entity. In this process of separation, the control-related assumptions are important. The Reynold's number should be small (i.e., laminar flow), the channels should be wide and rigid, and the fluids should have substantially constant and similar viscosity.

The Zimm model describes the polymer dynamics in a dilute solution. The diffusivity (D) and the relaxation time (τ) in the solvent are given as

$$D ∼ \frac{{k}_{B} T}{η {M}^{v}} \qquad ( 3 )$$

$$τ ∼ \frac{η {M}^{3 v}}{{k}_{B} T} \qquad ( 4 )$$

where k_{B} is Boltzmann's constant, T is the temperature, η is the viscosity of the solvent, M is the molecular weight of the solute, and the exponent v is given by 0.588 in the exemplary solvent.

In the solution, the entity with high mass diffuses more slowly than the entity with the low mass due to its larger weight. Additionally, the mass of the entity is also related to the hydrodynamic radius. The permeation data for hydrogen isotopes were reported for tetrafluoroethylene and polyethylene and found that the value for hydrogen and D2 were quite different (D for Hydrogen ˜1.47×10⁻⁷ cm²/s whereas for D2 the diffusion constant was ˜1.16×10⁻⁷ cm²/s). Similarly, for Li isotopes the value of the diffusion constant is different for two isotopes and the difference in diffusivity increases in certain environments and in the presence of specific solvents. This change in diffusivity can be seen in the context of the electrochemical isotope effect theory that has been derived thoroughly by Kavner et al. with reference to the Marcus charge transfer theory. There will be a difference in the relaxation time between the isotopes of different mass that can provide a sufficiently dynamic contrast to facilitate separation of the isotopes from the mixture using transverse diffusion.

There are several factors that may affect separation of the mixture containing the entities. In an example, separation of the mixture may depend on the flow rates of solution since the flow rate affects layers and streams thickness, residence time, and stream split ratio. The separation of the mixture may also depend on layers and streams thickness which may be determined based on flow rate and residence time. Other factors include flow speed residence time, and stream split ratio. The thin fluid layers and streams separator 800 may also include a very thin fiber liner to provide a stabilizing influence on fluid flow in the pipe and which holds the fluid by capillary forces. The size, type, and thickness of the fiber may also affect the separation of the mixture.

Diffusion is also influenced by temperature. At the point when surrounding temperature increases, the solvent substances diffuse more rapidly in a fluid. Based on this principle, the transverse migration of the entities in appropriate solvent occurs rapidly through the interface boundary of the laminar flow in the microfluidic channel. FIG. 9 is a cross-sectional schematic view of a thin fluid layers and streams separator 900 that uses concentration gradients and temperature to separate entities, according to an embodiment. Except as otherwise disclosed herein, the thin fluid layers and streams separator 900 may be the same as or substantially similar to any of the separation devices disclosed herein. The thin fluid layers and streams separator 900 includes heating element 912 mounted to the rest of the thin fluid layers and streams separator 900. The thin fluid layers and streams separator 900 may also include one or more thermocouples 914 (e.g., two K-type thermocouples) that may be position close to the inlet 902 and exit 908 to monitor the normal ambient temperature. The heating element 912 will control the temperature and the input power will be regulated in such a manner to obtain a desired, consistent and steady substrate temperature. The thin fluid layers and streams separator 900 may have the advantage of maintaining appropriate temperature mainly due to a short heat exchange distance.

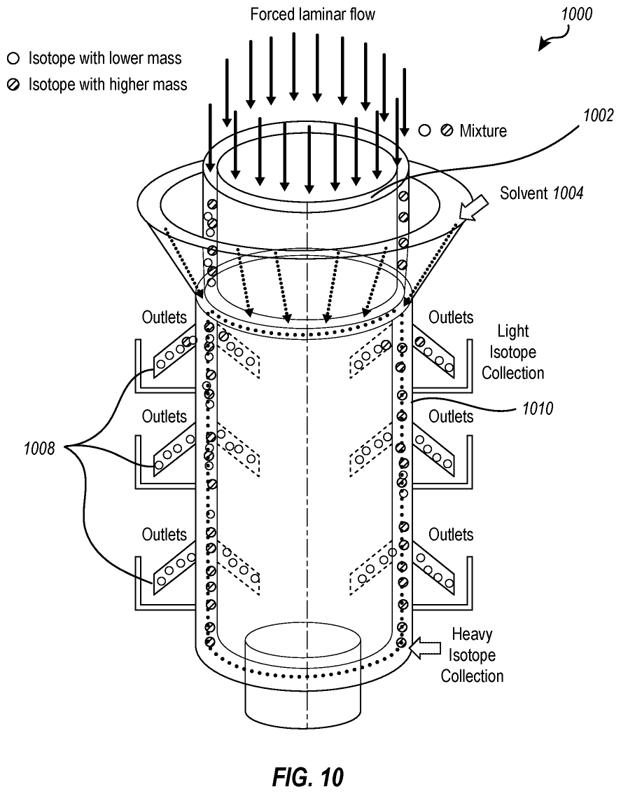

FIG. 10 is a cross-sectional schematic of a thin fluid layers and streams separator 1000, according to an embodiment. Except as otherwise disclosed herein, the thin fluid layers and streams separator 1000 may be the same as or substantially similar to any of the separation devices disclosed herein. The thin fluid layers and streams separator 1000 includes an inlet 1002 for the mixture of entities (e.g., mixture of an isotope with lower mass and an isotope with higher mass). The inlet 1002 may exhibit an annular shape. The thin fluid layers and streams separator 1000 also includes an inlet 1004 for the solvent. The thin fluid layers and streams separator 1000 includes a cylindrical channel 1010. The channel 1010 may include a tube of small diameter to create the annular region for laminar flow. The channel 1010 includes a plurality of outlets 1008 along a length of the channel 1010.

During use of the thin fluid layers and streams separator 1000, more massive entities will move toward the wall of the cylinder channel 1010 more completely than lighter entities due to the diffusion across the interface of two overlaid laminar layers and streams of solution and the boundary constraint at the cylinder channel 1010. Therefore, the denser entities are concentrated near the bottom of the tube wall and lighter entities can be collected in fluid exiting through outlets 1008 in the channel 1010 at a higher concentration than in the input bulk solution. Therefore, it is possible to separate more dense entities in a thin layers and streams separator in a short period of time. It is also possible to sequentially remove entities at different locations along the length of the tube channel as illustrated in FIG. 10 through small outlets 1008 or through porous media. The time for separation depends on various factors including flow rate, diffusivity, thickness of the channel, and solvent type. The viscosity of the fluid, which is strongly influenced by temperature may also affect the time for separation. The time for separation may also be influenced by the location of the collection port relative to the input of fluid.

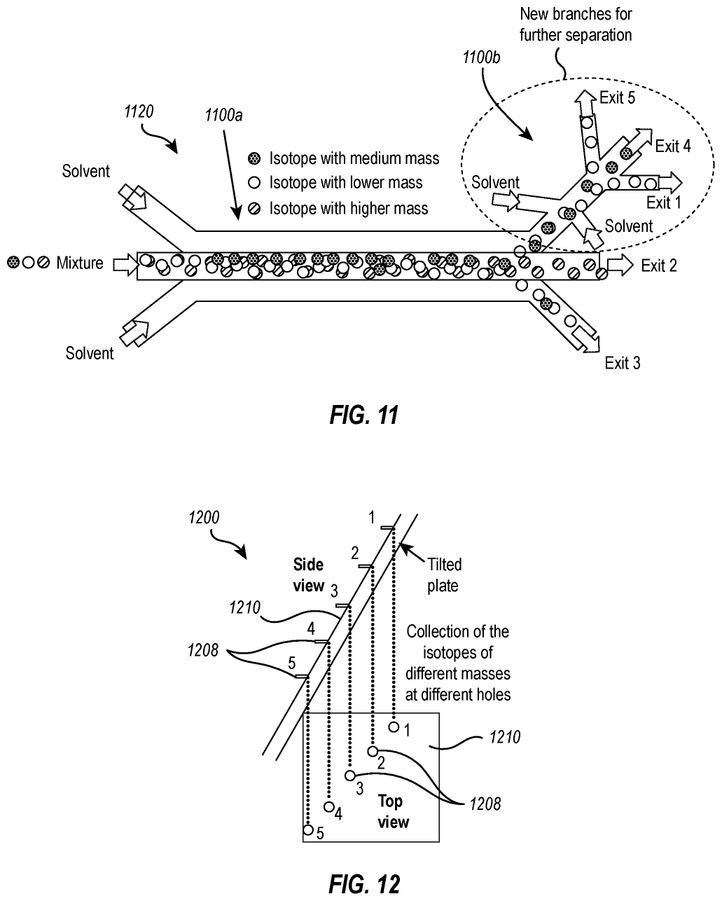

FIG. 11 is a cross-sectional schematic of system 1120 that includes a plurality of thin fluid layers and streams separators connected in series, according to an embodiment. Except as otherwise disclosed herein, each of the plurality of the thin fluid layers and streams separators may be the same as or substantially similar to any of the thin fluid layers and streams separators disclosed herein. The system 1120 may include a first thin fluid layers and streams separator 1100a and a second thin fluid layers and streams separator 1100b. In the illustrated embodiment, each of the first and second thin fluid layers and streams separators 1100a, 1100b may be the same as the thin fluid layers and streams separator 800 of FIG. 8. At least one of the outlets of the first thin fluid layers and streams separator 1100a may be connected to a second thin fluid layers and streams separator 1100b such that at least a portion of a mixture dispensed by the first thin fluid layers and streams separator 1100a is received by the second thin fluid layers and streams separator 1100b. In particular, at least one of the outlets of the first thin fluid layers and streams separator 1100a is in fluid communication with the inlet of the second thin fluid layers and streams separator 1100b. The system 1120 may be configured to further separate the mixture to make the mixture dispensed from the system 1120 more pure and/or separate three or more entities of the mixture.

The thin fluid layers and streams separators disclosed herein may exhibit a structure other than the structures illustrated in FIGS. 1-11. FIG. 12 includes side and top views of a thin fluid layers and streams separator 1200 that is a field-flow fractionation (FFF) device, according to an embodiment. The FFF device uses a separation technique where a field is applied to a fluid suspension or solution pumped through an elongate long and narrow channel 1210, perpendicular to the direction of flow, to cause separation of the entities present in the fluid, depending on their differing “mobilities” under the force exerted by the field. In a FFF device, the applied field can be asymmetrical flow through a semi-permeable porous material, gravitational, rotational, electrostatic, thermal-gradient, etc. In all cases, the separation mechanism originates from the differences in entity mobility under the forces of the field, in equilibrium with the forces of diffusion: an often-parabolic laminar-flow-velocity profile in the channel determines the velocity of a particular entity, based on its equilibrium position from the wall of the channel. In a particular example, the FFF device may include a 3-plate stack (8×2-inch tilted plate) separator where gravitational field (the change in inclination of tilted plate will create a different force along flow direction) and a set of layers and streams thin porous layers or sets of channels, tubes, or streams and collectors affects the flow rate, angle, collector locations, and layers and streams thickness. The FFF device may include a plurality of holes 1208 through which entities of different mass or components of different mass can be collected (based on deflection due to different diffusivity).

As previously discussed above, the thin fluid layers and streams separators disclosed herein may include a porous material. In an example, the porous material may include two-dimensional materials, such as one or more of graphene, MoS₂, MXene, metal-organic frameworks (MOFs), and covalent organic framework nanosheets. In an example, the porous material may include nanoporous materials. Nanoporous materials may have the potential to separate hydrogen isotopes by a process known as kinetic quantum sieving. Examples of nanomaterials include CNT, rGO, and MOFs. In an example, the porous material may include functionalized multiwalled carbon nanotube-ZnO composite that have shown specific selectivity towards specific ions.

As previously discussed above, the thin fluid layers and streams separators may include and/or receive a solvent. Solvents may play an important role in the separation of ions. In the case of the thin layers and streams laminar flow separator, an example of a solvent may include a low-density solvent such as isopropanol, included in a small amount. An example of a high-density solvent includes pyridinium/aluminum chloride based ionic fluid which may influence the separation of higher density isotopes such as those of calcium, copper and cobalt.

Any of the thin fluid layers and streams devices disclosed herein may include one or more additional components other than what is illustrated in the drawings. For example, any of the thin fluid layers and streams devices disclosed herein may include at least one of a pump, coupler, pipe, or mounting equipment.

### Working Example 1

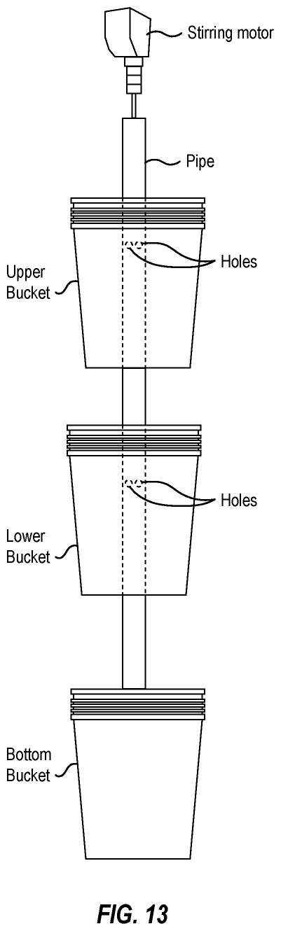

FIG. 13 illustrates the thin fluid layers and streams separator of working example 1. The thin layers and streams separator of working example 1 was fabricated using a 2-inch diameter plastic pipe (i.e., the at least one support) that had 2 mm holes drilled around the perimeter of the pipe approximately 5 feet below the top of the pipe. A stirring motor (i.e., the force application device) with an impeller substantially equal to the diameter of the pipe was mounted at the top of the pipe to rotate it at various speeds. The pipe was inserted through two buckets with 2.2 inch holes (clearance of 0.1 inch all around). The buckets thus surrounded the spinning pipe and collected fluid that was ejected from the spinning pipe. The upper bucket collected fluid near the top of the pipe, and the bottom bucket collected the fluid ejected from the holes around the perimeter near the bottom of the spinning pipe. A bottom bucket with no holes collected the fluid that was not ejected through the side holes as it exited the bottom of the spinning pipe. Black electrical tape was used to cover most holes and a needle was used to perforate the black tape covering most of the drilled holes to reduce the size of each hole to about 0.5 mm for each pin hole, rather than the initial 2 mm holes, to restrict flow out from the set of holes into the collection bucket. The buckets were secured to a mounting brace using duct tape. The bottom of the pipe was placed in a bucket to collect the main flow of fluid. Fluid was injected at the top of the spinning pipe using a peristaltic pump and a flexible tube mounted near the opening of the pipe that directed the flow to the inner wall of the pipe.

A solution containing 1522 ppm of lithium, 1000 ppm of sodium, 1000 ppm of potassium, 1000 ppm of magnesium, and 0.1% Tween 20 (nonionic surfactant) that was diluted by a factor of 10 was pumped into the spinning tube of the thin fluid layers and streams separator of working example 1 using a peristaltic pump (i.e., the fluid source) at a flowrate of approximately 50 ml per minute. Solution collected from the lower bucket from the small holes in the pipe spinning at 1250 RPM was diluted by a factor of 100 and sent for ICP analysis at an independent lab. The results were 1.40, 1.38, 1.48, and 1.92 ppm for magnesium, potassium, sodium, and lithium, respectively. The ratio of the heavier elements (magnesium, potassium, and sodium) relative to that of the much lighter reference element (lithium) increased by an average of about 12%, which suggested that the thin fluid layers and streams separator of working example 1 was able to separate entities based on mass.

### Working Example 2

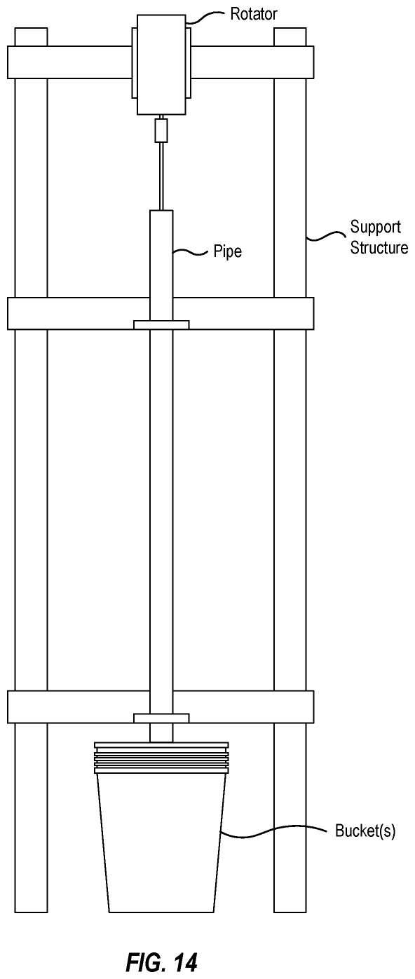

FIG. 14 illustrates the thin fluid layers and streams separator of working example 2. The thin fluid layers and streams separator of working example 2 was substantially the same as the thin fluid layers and streams separator of working example 1 except that the thin fluid layers and streams separator of working example 2 included a more rigid support structure, mounted bearings, and a faster, and a variable speed motor for rotation. FIG. 14 illustrates a rotatable cylinder or pipe (center), buckets (surrounding cylinder), rotator (top of cylinder), and structural support of the thin fluid layers and streams separator of working example 2.

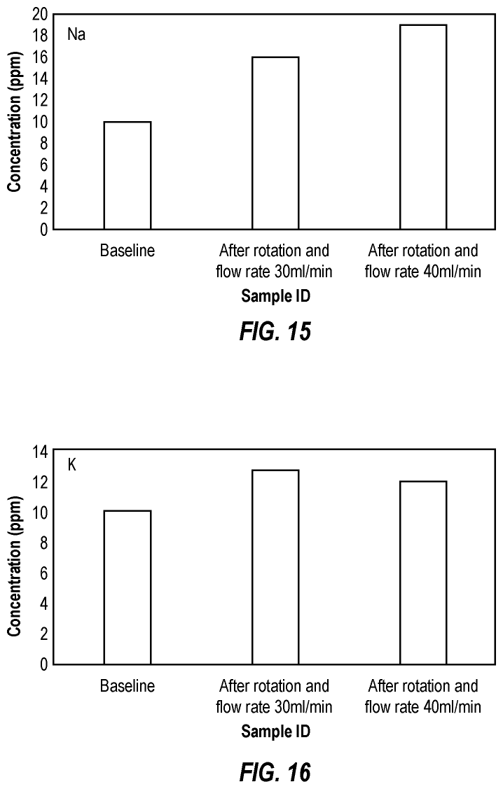

The same stock solution used in working example 1 was used in working example 2 (e.g., a solution including 1522 ppm of lithium, 1000 ppm of sodium, 1000 ppm of potassium, 1000 ppm of magnesium, and 0.1% Tween 20), with the solution being diluted by a factor of 10 for working example 2. The solution flow rate was 30-40 ml/minute. The residence time was approximately 15 seconds. During the test, samples were collected from the lower bucket. After the test, the collected samples were diluted by a factor of approximately 10 before being analyzed by inductively coupled plasma spectroscopy. The results from tests at the different flow rates are shown in comparison to the baseline solution in FIGS. 15-17.

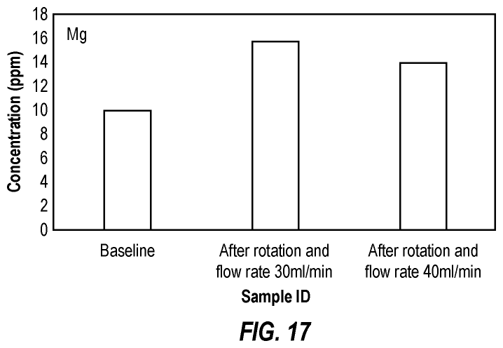

FIG. 15 is a graph showing a comparison of baseline solution ICP concentration of sodium in samples collected from the bottom holes in the rotatable cylinder of the thin fluid layers and streams separator of working example 2 at two solution flow levels as indicated. FIG. 16 is a graph showing a comparison of baseline solution ICP concentrations of potassium in samples collected from the bottom holes in the rotatable cylinder of the thin fluid layers and streams separator of working example 2 at two solution flow levels as indicated. FIG. 17 is a graph showing a comparison of baseline solution ICP concentration of magnesium in samples collected from the bottom holes in the rotatable cylinder of the thin fluid layers and streams separator of working example 2 at two solution flow levels as indicated. All of the results for sodium, potassium, and magnesium showed a significant concentration increase for the ions in the collected stream relative to the baseline solution. The increase in ion concentrations varies for the 30 versus 40 ml/minute test flowrate.

### Working Example 3

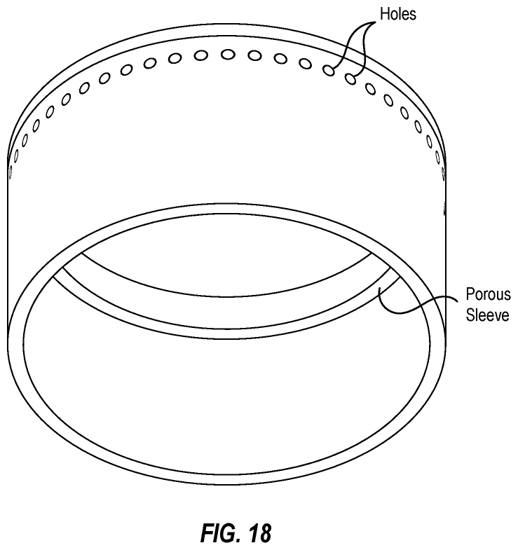

FIG. 18 shows a portion of the thin fluid layers and streams separator of working example 3. The thin fluid layers and streams separator of working example 3 was substantially the same as the thin fluid layers and streams separator of working example 2 except that the thin fluid layers and streams separator included an inner sleeve of porous material near the holes to prevent turbulence near the holes. The holes were covered by black electrical tape and one pin hole through the tape was used to collect the fluid and control the collection rate.

The thin fluid layers and streams separator of working example 3 was tested by flowing a solution down the rotatable cylinder that contained approximately 75 ppm cerium, 75 ppm dysprosium, 81 ppm neodymium, 78 ppm lanthanum, 95 ppm magnesium, 120 ppm lithium, and 84 ppm erbium. The rotatable cylinder was rotated at 655 RPM and 1300 RPM.

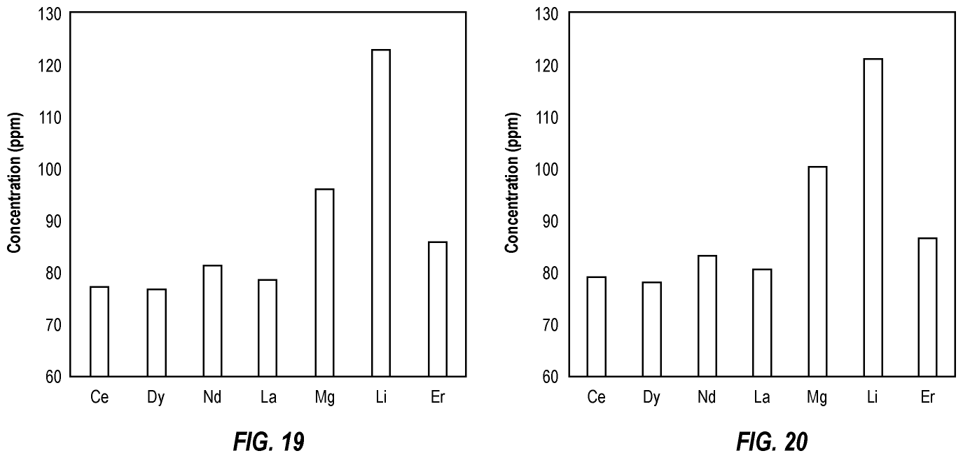

FIG. 19 is a graph showing a comparison of element concentration data (in ppm) for selected elements collected from the thin fluid layers and streams separator of working example 3 when the cylinder thereof was rotated at 655 RPM. FIG. 20 is a graph showing a comparison of element concentration data (in ppm) for selected elements collected from the thin fluid layers and streams separator of working example 3 when the cylinder thereof was rotated at 1300 RPM. The data in FIGS. 19 and 20 show that elements generally had an increase in concentration when collected from the outer holes near the bottom of the rotatable cylinder when rotated at higher velocity.

### Working Example 4

Although the increases in concentrations of the entities in working examples 1-3 were encouraging, it is believed that as the speed of the rotation increases, there may be more potential for the fluid to become somewhat turbulent. It is currently believed that the turbulence may cause mixing of the thin fluid layers and streams thereby making the separation more difficult and less efficient. Thus, a thin fluid layers and streams separator that was similar to the thin fluid layers and streams separator schematically shown in FIG. 2A was constructed that included thin porous layers or sets of channels, tubes, or streams. The thin porous layer was made using fibrous material (large thin sheets of KIM wipes) that were used to line the inner wall of the rotatable cylinder. The thin porous layer was inserted to mitigate potential turbulence along the spinning wall. Because the thin porous layer holds the fluid by capillary forces, the fluid is not as free to flow and form turbulent regions or wavefronts. Thus, the thin porous layer holds the fluid to the spinning wall and allows the centrifugal forces to perform the separation through the thin porous layer towards the tube wall as the fluid flows down through the tube without turbulent mixing between the various layers.

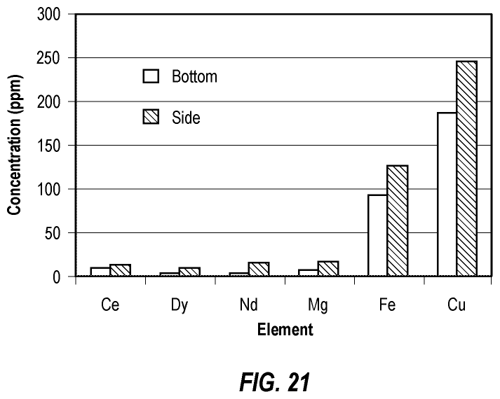

The thin fluid layer separator of working example 4 was tested using 2 solutions. The first solution included lithium ions and was flowed down the rotatable cylinder at 1300 RPM and 60 ml/minute flow rate. The collected fluid from the first solution was analyzed by ICP MS and the analysis showed that the lithium ion concentration decreased by 23% in the fluid extracted from the side ports. A second solution included cerium, dysprosium, neodymium, magnesium, iron, and copper ions and was flowed down the rotatable cylinder at 1800 RPM and 60 ml/minute flow rate. FIG. 21 is a graph showing the results of the analysis of the collected fluid from the second solution. FIG. 21 show further enhancements in the separation between the bottom discharge and the side port in which the concentration is enhanced.

### Working Example 5

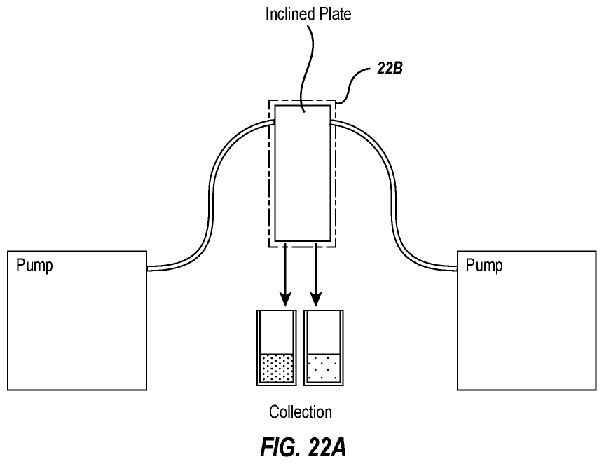

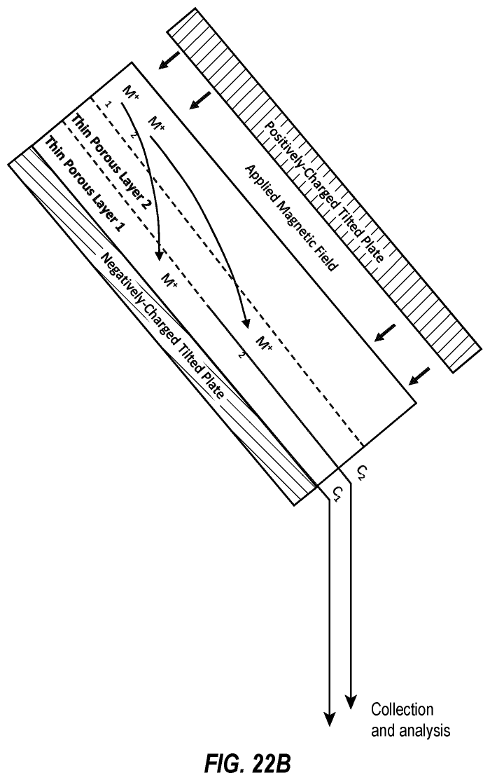

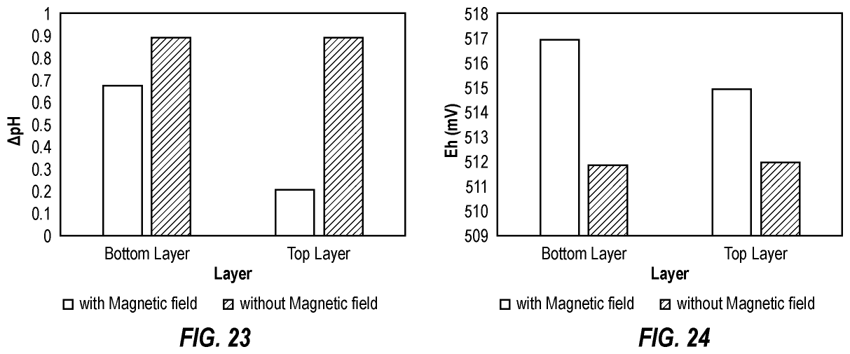

FIG. 22 schematically illustrates the thin fluid layer separator of working example 5 that included an inclined surface. The thin fluid layer separator of working example 5 included a magnet and a plate with two thin layers formed using two very thin sheets of fibrous material. A solution was pumped to the top of the inclined plate containing the thin fibrous sheets and placed near the magnet, as shown in FIG. 7. The ions deflected according to their mass as the solution flowed down the layers on the inclined surface and the two solutions (one from the top and one from the bottom layer) were collected at the bottom of the plate, as can be seen in FIG. 22. The solution included Fe³⁺, Fe²⁺, Cu²⁺, and Li⁺ (each 0.05 M) (using chloride salt). The tests were done with an applied magnetic field, with reversed magnetic field, and without any magnetic field. The samples from the top layer and bottom layers were measured with pH, Eh (reduction potential), and Cu selective probes. Different solution colors were observed in the test for the fluids that were collected from each layer. FIGS. 23 and 24 are graphs that illustrates the changes in the pH and Eh, respectively, of the collected solution, wherein differences in the pH and Eh indicates that the collected solutions include different concentrations of the ions. It can be seen from FIG. 23 that the pH is significantly different (0.7 pH units) for the solution collected from the bottom and top layers, when a magnetic field was applied. However, no significant change in pH was noted in the control test when the magnetic field was removed. Interestingly, when the polarity of the magnet was reversed, we have noted the opposite trend for pH, Eh, and Cu selective probe readings.

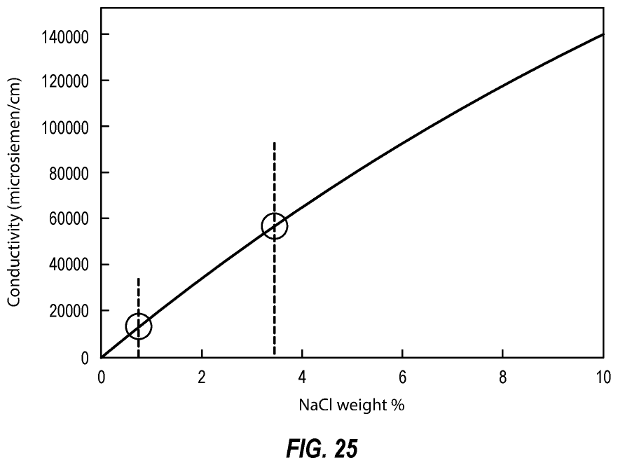

An additional test was performed on the thin fluid layers and streams separator of working example 5 for 3.5% and 7.0% NaCl solutions. The solutions were allowed to pass through the device and were collected at the bottom of the plate. The solutions from the top and bottom layers were examined using electrochemical impedance spectroscopy (EIS) to determine solution conductivity. A three-electrode method was used for EIS tests. The Nyquist plots were obtained and for model fitting using a simple method, the solution resistance for one layer solution was two times higher than that of the second one. FIG. 25 is a graph illustrating the NaCl concentration of the collected solutions versus conductivity for the NaCl solution and the treated desalinated solution. It can be seen from FIG. 25 that NaCl concentration in the solution reduced to ⅓^{rd} of its initial value when treated using the present setup with an impressively low residence time of less than 30 seconds.

### Working Example 6

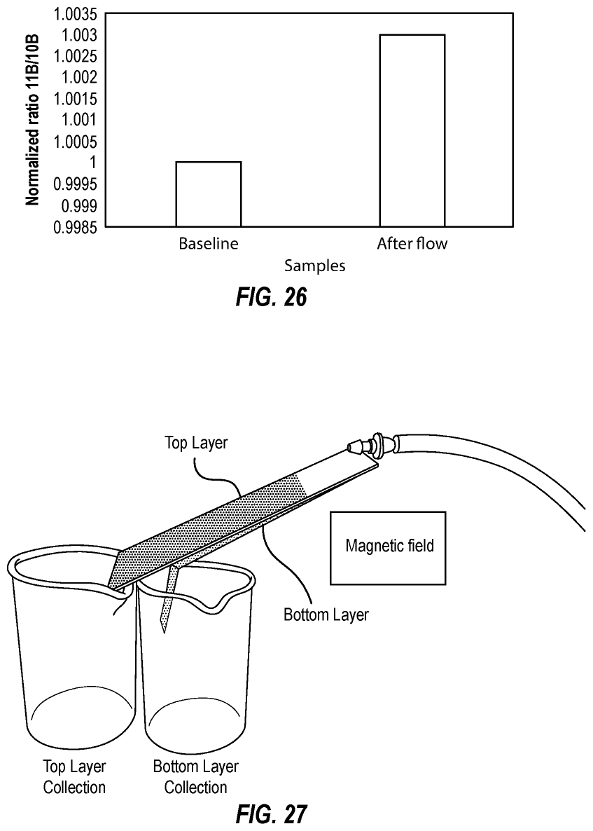

The thin fluid layers and streams separator illustrated in FIG. 10 was fabricated using 2-inch diameter plastic pipe that had 2-mm holes drilled around the perimeter of the pipe approximately 5 feet below the top of the pipe. A provision was made so that a mixture of isotopes can flow along the annular passage between the tube and the thin porous layer. Two buckets with 2.2-inch holes in them were placed with the pipe through the buckets to collect fluid—one to collect fluid near the top through additional holes if desired as well as to protect the bottom bucket from spillage from the top injection site, and one bucket to collect fluid from the holes near the bottom of the pipe. A bottom bucket with no holes collected the fluid that was not ejected through the side holes. The device also included a porous ring (see FIG. 18) inserted between the holes and the inner pipe surface to facilitate laminar flow. The buckets were secured to a mounting brace. The bottom of the pipe was placed in a bucket to collect the main flow of fluid. Fluid including a mixture of boron 10 and boron 11 was injected at the top of the long tube using a tube mounted near the opening of the pipe that directed the flow to the inner wall of the pipe. FIG. 26 is a graph illustrating the ratio of boron 11 to boron 10 of the collected solution detected using a multi-collector ICPMS. FIG. 26 shows a significant concentration of the boron 11 isotope, as compared to the baseline, achieved in a relatively short residence time. Further concentration could be achieved through processing the output repeatedly, in series.

### Working Example 7

FIG. 27 illustrates a thin fluid layers and streams separator, according to an embodiment. The thin layer fluid separator illustrated in FIG. 27 included a thin layer made of thin threads wrapped around a thin plate in two single layers—a top layer and a bottom layer that are separated by a plastic sheet about one inch below the starting point. The fine threads created small parallel fluid channels between them. The threads and resulting small fluid channels were oriented parallel to the inclined plane on which they were placed. The thin layer fluid separator also included application of a magnetic field. A fluid solution including 0.5 g of CuSO₄, 0.5 g of Fe₂(SO₄), 0.5 g of FeSO₄, and 200 ml of 0.04 M H₂SO₄ was passed over the thin threads and associated small channels between them where the magnet influences the ions as they flow down the plate. The ions that are moved to the top layer of threads and associated channels are separated into a separate beaker from those that remain in the bottom layer. The solution from the bottom layer was passed over the device a second time and the bottom layer solution from that test was collected and compared with the results of the top layer passed over twice and the top layer portion collected from the second run.

The results are presented below in Table 1 to show the effects of flow rate and magnet orientation on the separation of H⁺ ions (pH measurement based), Cu²⁺ ions (selective ion electrode measurement based), and Fe³⁺/Fe²⁺ ion ratio (Eh measurement based). Table 1 demonstrates that the separator illustrated in FIG. 27 is more effective in specific magnetic field orientations and high flow rates. In the 1^{st} magnet orientation, the north pole of the magnet was oriented horizontally, perpendicular to the flow. In the 2^{nd} magnet orientation, the north pole of the magnet was oriented vertically, perpendicular to the flow. In the 3^{rd} magnet orientation, the north pole of the magnet was oriented parallel to the flow. The low velocity flow rate was 1 cm/s, while the high velocity flow rate was 2 cm/s.

TABLE 1

| | [H⁺] | [Fe²⁺/Fe³⁺] | [Cu²⁺] |
|---|---|---|---|
| Condition | difference % | difference % | difference % |
| 1^{st} magnet orientation | 10.108 | 5.7367 | 15.4156 |
| 2^{nd} magnet orientation | −7.4302 | 24.1836 | 23.9878 |
| 3^{rd} magnet orientation | 5.6361 | −4.4298 | 3.2594 |
| Low flow rate | 10.108 | 5.7367 | 15.4156 |
| High flow rate | 16.7662 | 12.8113 | 13.5321 |

### Working Example 8

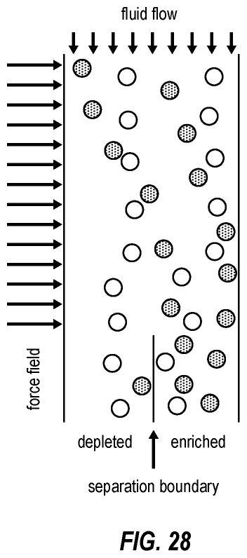

FIG. 28 shows a general schematic diagram in which the separation of ions, molecules or particles is accomplished due to a force acting on a flowing stream of fluid with those entities. FIG. 28 thus schematically illustrates the general principal by which various of the described embodiments operates.

### Working Example 9

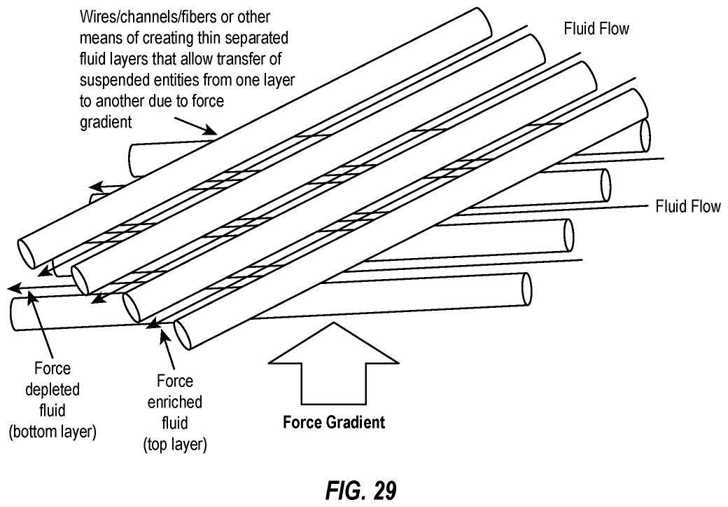

FIG. 29 shows another working example of application of force to entities in a lower and upper set of fluid streams in very small channels formed between parallel sets of wires. The two sets of wires are offset in angle to create crossing sets of microchannels, areas in which the flow streams in the lower set of wires are in contact with the flow streams in the upper set in a region in which a force is applied. In an example the force is applied using a high-power magnet. In application the sets of wires were vertical to maintain equal flows of liquid in the two sets of channels formed between the wire sets. The results showed that by circulating the liquid from one half of the cell twice through the device, this allowed for an enrichment in H+ ions by 3-9% as well as an enrichment of Fe³⁺ relative to Fe²⁺ of about 7%.

### Working Example 10

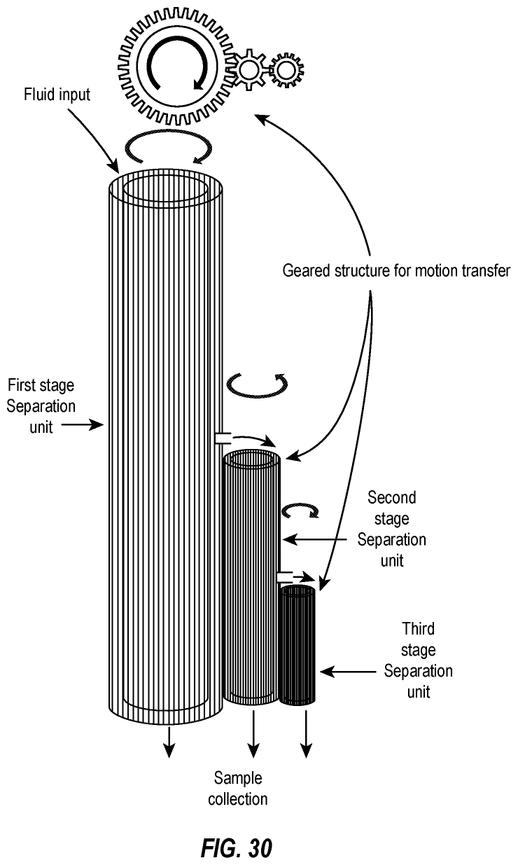

As shown in FIG. 30, Applicant also envisions the use of geared structures for the motion transfer. A multi-stage separating unit is fabricated where fluid from the exit hole is transferred to a secondary rotating unit. Based on the design characteristics of the secondary unit (radius, thickness of thin shell, rotation etc.) additional separation is possible. Similarly multi-stage separation can be realized. Note that the gear ratio determines the relationship between the number of teeth on the driving gear (the one supplying the power) and the driven gear (the one receiving the power). The gear ratio affects the speed and torque of the output secondary shaft-cylindrical structure compared to the input-primary cylindrical structure. Similarly, other combinations are possible where effective separation can be done by utilizing multiple rotational units.

While various aspects and embodiments have been disclosed herein, other aspects and embodiments are contemplated. The various aspects and embodiments disclosed herein are for purposes of illustration and are not intended to be limiting.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” “involves,” “contains,” etc.), and similar terms as used herein, including within the claims, shall be inclusive and/or open-ended, shall have the same meaning as the word “comprising” and variants thereof (e.g., “comprise” and “comprises”), and do not exclude additional un-recited elements or method steps, illustratively. Unless defined otherwise, all technical and scientific terms used herein have the same meaning as commonly understood by one of ordinary skill in the art to which the present disclosure pertains.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

As used herein, the term “between” includes any referenced endpoints. For example, “between 2 and 10” includes both 2 and 10.

Some ranges may be disclosed herein. Additional ranges may be defined between any values disclosed herein as being exemplary of a particular parameter. All such ranges are contemplated and within the scope of the present disclosure.

Disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure. Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Accordingly, the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

We claim:

1. A thin fluid layers or streams-based separation device for separating atoms, ions, isotopes, molecules, or fine particles, comprising:
at least one support having a surface, the at least one support including at least one inclined surface, at least one rotatable cylinder, or a channel or tube or collection of channels or tubes or other fluid pathways;
a fluid source that is configured to hold a fluid that includes one or more entities to be separated therein, the fluid source configured to apply a fluid to the surface of the at least one support, wherein the separator is configured to form one or more thin fluid layers or streams, channels, tubes or other fluid pathways on the surface after receiving the fluid from the fluid source;
at least one force application device configured to apply a desired force to a portion of the supported thin fluid layers or streams, tubes, channels or other fluid pathways, the force including at least one of a centrifugal force, a magnetic force, an electric or electrostatic force, an electrolytic force, a concentration gradient, a hydrophobic force or a hydrophilic force; and
one or more collection devices, channels, tubes, or layers positioned to receive fluid enriched or depleted in atoms, ions, isotopes, molecules, or fine particles of the entities to be separated, leaving a region in which the desired force is applied.

2. The thin fluid layers or streams-based separation device of claim 1, wherein the at least one support defines one or more holes, channels, tubes or layers therein and the one or more collection devices are positioned adjacent to the one or more holes, channels, tubes, or layers.

3. The thin fluid layers or streams-based separation device of claim 1, wherein the at least one support includes the at least one rotatable cylinder, and wherein rotating the at least one rotatable cylinder with the at least one force application device causes the centrifugal force to be applied to the thin fluid layers or streams, tubes, channels or other fluid pathways.

4. The thin fluid layers or streams-based separation device of claim 1, wherein the at least one support includes the at least one inclined surface.

5. The thin fluid layers or streams-based separation device of claim 1, wherein a thickness of the thin fluid layers or streams is selected by controlling at least one of a flow rate of the fluid dispensed from the fluid source, a viscosity of the fluid, a thickness of one or more thin porous layers or sets of channels, tubes, or streams disposed on the surface, selected properties of the one or more thin porous layers or sets of channels, tubes, or streams, an angle of incline of the surface, a length of the surface, or an angular velocity at which the surface rotates.

6. The thin fluid layers or streams-based separation device of claim 1, further comprising one or more thin porous layers disposed on the surface configured to reduce flow turbulence.

7. The thin fluid layers or streams-based separation device of claim 6, wherein the one or more thin porous layers or sets of channels, tubes, or streams include chromatography or hydrophilic or hydrophobic separation materials.

8. The thin fluid layers or streams-based separation device of claim 1, wherein the at least one force application device includes one or more magnets that are configured to apply a magnetic field to the thin fluid layers or streams, tubes, channels or other fluid pathways.

9. The thin fluid layers or streams-based separation device of claim 1, wherein the at least one force application device includes one or more electrodes configured to apply an electric or electrostatic field to the thin fluid layers or streams, tubes, channels or other fluid pathways, without directly contacting the fluid.

10. The thin fluid layers or streams-based separation device of claim 1, wherein the at least one force application device includes one or more electrodes positioned to directly contact the thin fluid layer or stream, tubes, channels or other fluid pathways.

11. The thin fluid layers or streams-based separation device of claim 1, wherein the at least one force application device includes one or more sequential ring electrodes.

12. The thin fluid layers or streams-based separation device of claim 1, wherein the at least one force application device is configured to apply an oscillating force.

13. The thin fluid layers or streams-based separation device of claim 1, wherein the at least one force application device includes at least one solvent inlet configured to contact at least one solvent with the fluid to form a concentration gradient.

14. A system that includes a plurality of separation devices, wherein at least one of the plurality of separation devices includes the thin fluid layers or streams-based separation device of claim 1, and wherein each of the plurality of separation devices are positioned in series or cascading sequence to optimize separation of specific entities in the fluid source.

15. A thin fluid film separator, comprising:
at least one support having a surface, the at least one support including at least one inclined surface, at least one rotatable cylinder, or a channel or tube, or a collection of channels or tubes;
a fluid source that is configured to hold a fluid that includes one or more entities to be separated therein, the fluid source being configured to apply the fluid to the surface of the at least one support, wherein the surface of the at least one support is configured to form a thin fluid film thereon after receiving the fluid from the fluid source;
one or more collection devices positioned proximate to the at least one support to receive fluid leaving the surface of the at least one support; and
at least one force application device configured to apply a force to a portion of the thin fluid film on the surface of the at least one support, the force including at least one of a centrifugal force, a magnetic force, an electric or electrostatic force, an electrolytic force, a concentration gradient, a hydrophobic force or a hydrophilic force.

16. The thin fluid film separator of claim 15, wherein the fluid is a liquid.

17. The thin fluid film separator of claim 15, wherein the at least one support defines one or more holes therein and the one or more collection devices are positioned adjacent to the one or more holes.

18. The thin fluid film separator of claim 15, wherein the at least one support includes the at least one rotatable cylinder, and wherein rotating the at least one rotatable cylinder with the at least one force application device causes the centrifugal force to be applied to the thin fluid film to concentrate or deplete a target entity within the fluid source.

19. The thin fluid film separator of claim 15, wherein the at least one force application device includes:
(i) one or more magnets that are configured to apply the magnetic force to the thin fluid film;
(ii) one or more electrodes configured to apply the electric or electrostatic force to the thin fluid film without contacting the fluid;
(iii) one or more electrodes positioned to directly contact the fluid;
(iv) one or more sequential ring electrodes;
(v) wherein the at least one force application device is configured to apply an oscillating force; or
(vi) wherein the at least one force application device includes at least one solvent inlet configured to contact at least one solvent with the fluid to form a concentration gradient.

20. A method for separating atoms, ions, isotopes, molecules, or fine particles, the method comprising:
providing a thin fluid layers or streams-based separation device comprising:
at least one support having a surface, the at least one support including at least one inclined surface, at least one rotatable cylinder, or a channel or collection of channels or fluid pathways;
a fluid source that is configured to hold a fluid that includes one or more entities to be separated therein, the fluid source being configured to apply a fluid to the surface of the at least one support, wherein the separator is configured to form one or more thin fluid layers or streams on the surface after receiving the fluid from the fluid source;
a force application device configured to apply a desired force to a portion of the supported thin fluid layers, tubes, channels, or streams, the force including at least one of a centrifugal force, a magnetic force, an electric or electrostatic force, an electrolytic force, a concentration gradient, a hydrophobic force or a hydrophilic force; and
one or more collection devices, channels, tubes, or layers positioned to receive fluid enriched or depleted in atoms, ions, isotopes, molecules, or fine particles of the entities to be separated, leaving a region in which the desired force is applied; and
using the thin fluid layers or streams-based separation device to separate select atoms, ions, isotopes, molecules, or fine particles of the entities within the fluid source.
